(19) United States
(12) Patent Application Publication
(10) Pub. No.: US 2012/0226691 A1
(43) Pub. Date: Sep. 6, 2012

(54) SYSTEM FOR AUTONOMOUS DETECTION AND SEPARATION OF COMMON ELEMENTS WITHIN DATA, AND METHODS AND DEVICES ASSOCIATED THEREWITH

(76) Inventor: Tyson LaVar Edwards, Harrisville, UT (US)

(21) Appl. No.: 13/411,563

(22) Filed: Mar. 3, 2012

Related U.S. Application Data
(63) Continuation-in-part of application No. 13/039,554, filed on Mar. 3, 2011.
(60) Provisional application No. 61/604,343, filed on Feb. 28, 2012.

(51) Int. Cl. G06F 17/30

(52) U.S. Cl. 707/737; 707/E17.046

(57) ABSTRACT

A data interpretation and separation system for identifying data elements within a data set that have common features, and separating those data elements from other data elements not sharing such common features. Commonalities relative to methods and/or rates of change within a data set may be used to determine which elements share common features. Determining the commonalities may be performed autonomously by referencing data elements within the data set, and need not be matched against algorithmic or predetermined definitions. Interpreted and separated data may be used to reconstruct an output that includes only separated data. Such reconstruction may be non-destructive. Interpreted and separated data may also be used to retroactively build on existing element sets associated with a particular source.

### CROSS-REFERENCE TO RELATED APPLICATIONS

This Application claims priority to, the benefit of, and is a continuation-in-part of U.S. patent application Ser. No. 13/039,554 titled “DATA PATTERN RECOGNITION AND SEPARATION ENGINE”, filed on Mar. 3, 2011. This application also claims priority to, and the benefit of, U.S. Provisional Patent Application No. 61/604,343 titled “SYSTEM FOR AUTONOMOUS SEPARATION OF COMMON ELEMENTS WITHIN DATA, AND METHODS AND DEVICES ASSOCIATED THEREWITH”, filed on Feb. 28, 2012, which applications are hereby expressly incorporated herein by this reference, in their entireties.

### TECHNICAL FIELD

The disclosure relates to data interpretation and separation. More particularly, embodiments of the present disclosure relate to software, systems and devices for detecting patterns within a set of data and optionally separating elements matching the patterns relative to other elements of the data set. In some embodiments, elements within a data set may be evaluated against each other to determine commonalities. Common data in terms of methods and/or rates of change in structure may be grouped as like data. Data that may be interpreted and separated may include audio data, visual data such as image or video data, or other types of data.

### BACKGROUND

Audio, video or other data is often communicated by transferring the data over electrical, acoustic, optical, or other media so as to convey the data to a person or device. For instance, a microphone may receive an analog audio input and convert that information into an electrical, digital or other type of signal. That signal can be conveyed to a computing device for further processing, to a speaker, or other output which can take the electrical signal and produce an audio output. Of course, a similar process may be used for video data or other data.

When data is received, converted, or transmitted, the quality of the data may be compromised. In the example of audio information, the desired audio information may be received, along with background or undesired audio data. By way of illustration, audio data received at a microphone may include, or have added thereto, some amount of static, crosstalk, reverb, echo, environmental, or other unwanted or non-ideal noise or data. While improvements in technology have increased the performance of devices to produce higher quality outputs, those outputs nonetheless continue to include some noise.

Regardless of output quality, signals often originate from environments where noise is a significant component, or signals may be generated by devices or other equipment not incorporating technological improvements that address noise reduction. For instance, mobile devices such as telephones can be used in virtually any environment. When using a telephone, a user may speak into a microphone component; however, additional sounds from office equipment, from a busy street, from crowds in a convention center or arena, from a music group at a concert, for from an infinite number of other sources may also be passed into the microphone. Such sounds can be added to the user's voice and interfere with the ability of the ability of the listener on the other end of a phone call to understand the speaker. Such a problem can further be compounded where a mobile phone does not include the highest quality components, where the transmission medium is subject to radio frequency (rf) noise or other interference associated with the environment or transmission medium itself, or where the data is compressed during transmission in one or more directions of transmission.

Current systems for reducing background noise may make use of phase inversion techniques. In practice, phase inversion techniques use a secondary microphone. The secondary microphone is isolated from a primary microphone. Due to the isolation between microphones, some sounds received on the primary microphone are not received on the secondary microphone. Information common to both microphones may then potentially be removed to isolate the desired sound.

While phase inversion techniques can effectively reduce noise in some environments, phase inversion techniques cannot be used in certain environments. In addition to the requirement of an additional microphone and data channels for carrying the signals received at the additional microphone, the two microphones must have identical latency. Even a slight variance creates an issue where the signals do not match up and are then unable to be subtracted. Indeed, a variance could actually cause the creation of additional noise. Furthermore, because the isolation is performed using two microphones, noise cannot be filtered from incoming audio received from a remote source. As a result, a user of a device utilizing phase inversion techniques may send audio signals with reduced noise, but cannot receive signals to then have the noise thereafter reduced.

### SUMMARY

In accordance with aspects of the present disclosure, embodiments of methods, systems, software, computer program products, and the like are described or would be understood and which relate to data interpretation and separation. Data interpretation and separation may be performed by making use of pattern recognition to identify different information sources, thereby allowing separation of audio of one or more desired sources relative to other, undesired sources. While embodiments disclosed herein are primarily described in the context of audio information, such embodiments are merely illustrative. For instance, in other embodiments, pattern recognition may be used within image or video data, within binary or digital data, or in connection with still other types of data.

Embodiments of the present disclosure relate to data interpretation and separation. In one example embodiment, a computer-implemented method for interpreting and separating data elements of a data set may include accessing a data set. The data may be automatically interpreted by at least comparing a method and rate of change of each respective one of a plurality of elements within the data set relative to other of the plurality of elements within the data set. The data set may further be separated into one or more set components that each includes data elements having similar structures in methods and rates of change.

In accordance with additional embodiments of the present disclosure wherein methods and/or rates of change may be analyzed by generating fingerprints of data having three or more dimensions. The generated fingerprints may then be compared. Optionally, comparing the fingerprints can include scaling a fingerprint in any or all of three or more directions and comparing the scaled fingerprint to another fingerprint. Such a comparison may also include overlaying one fingerprint relative to another fingerprint.

Data sets interpreted and/or separated using embodiments of the present disclosure can include a variety of types of data. Such data may include, for instance, real-time data, streamed data, or file-based, stored data. Data may also correspond to audio data, image data, video data, analog data, digital data, compressed data, encrypted data, or any other type of data. Data may be obtained from any suitable source, including during a telephone call, and may be received and/or processed at an end-user device or at a server or other computing device between end user devices.

In some embodiments of the present disclosure, interpreting a data set may be performed by transforming data. Data may be transformed from an example two-dimensional representation into a three or more dimensional representation. Interpretation of the data may also include comparing methods and/or rates of change in any or all of the three or more dimensions. Interpreting data may introduce a delay in some data, with the delay often being less than about 500 milliseconds, or even less than about 250 milliseconds or 125 milliseconds.

In accordance with some embodiments of the present disclosure, interpreting and/or separating a data set can include identifying identical data elements. Such data elements may actually be identical or may be sufficiently similar to be treated as identical. In some cases, data elements treated as identical can be reduced to a single data element. Interpreting and separating a data set can also include identifying harmonic data, which can be data that is repeated at harmonic frequencies.

Harmonic data, or other sufficiently similar data at a same time, may further be used to alias a data element. A first data element can be aliased using a second data element by, for instance, inferring data on the first data element which is not included in the first data element but is included in the second data element. The data set being aliased may be a clipped data element.

A system for interpreting and separating data elements of a data set is disclosed and includes one or more computer-readable storage media having stored thereon computer-executable instructions that, when executed by one or more processors, causes a computing system to access a set of data, autonomously identify commonalities between elements within the set of data, optionally without reliance on pre-determined data types or descriptions, and separate elements of the set of data from other elements of the set of data based on the autonomously identified commonalities. In some embodiments, autonomous identification of commonalities between elements can include evaluating elements of a set of data and identifying similarities in relation to methods and rates of change.

When data elements are separated, a set of data elements determined to have a high likelihood of originating from a first source may be output, while elements determined to have a high likelihood of originating from one or more additional sources may not be included in output. Such an output may be provided by rebuilding data to include only one or more sets of separated data.

A system for autonomously interpreting a data set and separating like elements of the data set can include one or more processors and one or more computer-readable storage media having stored thereon computer-executable instructions. The one or more processors can execute instructions to cause the system to access one or more sets of data and interpret the sets of data. Interpreting data can include autonomously identifying data elements having a high probability of originating from or identifying a common source. The system may also retroactively construct sets of data using the interpreted data. Retroactively constructed data can include a first set of data elements which are determined to have a high probability of originating from or identifying a common source. Retroactive construction may include re-building a portion of accessed data that satisfies one or more patterns.

In some embodiments, identifying data elements having a high probability of originating from or identifying a common source can include comparing data elements within the one or more sets of data relative to other elements also within the one or more sets of data and identifying elements with commonalities. Such data may be real-time or file data, and can be interpreted using the data set itself, without reference to external definitions or criteria. Outputting data may include reconstructing data by converting data of three or more dimensions to two-dimensional data.

A method for interpreting and separating data into one or more constituent sets can include accessing data of a first format and transforming the accessed data from the first format into a second format. Using the data in the second format, continuous deviations within the transformed data can be identified and optionally used to create window segments. Fingerprints for deviations and/or window segments can be produced. The produced fingerprints can also be compared to determine a similarity between one or more fingerprints. Fingerprints meeting or exceeding a similarity threshold relative to other fingerprints below the similarity threshold can be separated and included as part of a common set.

Data that is transformed may be transformed from two-dimensional data to data of three or more dimensions, optionally by transforming data to an intermediate format of two or more dimensions. When optional window segments are identified, window segments can start and begin when a continuous deviation starts and ends relative to a baseline. The baseline may optionally be a noise floor.

In some embodiments, fingerprints are generated by identifying one or more frequency progressions. Such frequency progressions may be within window segments, each window segment including one or more frequency progressions. The number of frequency progressions, or fingerprints thereof, can be reduced. For instance, identical or nearly identical, window segments may be reduced, optionally to a single frequency progression or fingerprint. Frequency progressions that are identified may include progressions that are at harmonic frequencies relative to a fundamental frequency. Data can be inferred to a fundamental frequency based on progression data of harmonics thereof.

Fingerprints may be compared to determine similarity. Compared fingerprints may be in the same window segment, or in different window segments. Optionally, a fingerprint is compared to fingerprints of the same window segment in reducing fingerprints of a window segment, and to fingerprints of other window segments after reduction occurs. A fingerprint set may be created for fingerprints meeting or exceeding a similarity threshold, thereby indicating a likelihood of originating from a common source. Other fingerprints may be added to existing fingerprint sets when meeting or exceeding a threshold. In some cases, fingerprints having a similarity between two thresholds may be included in a set, whereas fingerprints above two thresholds are combined into a single entry in a fingerprint set. Fingerprints of a same set or above a similarity threshold may be output. Such output may include converting a fingerprint to a format of accessed data. Output data may be separated data that is a subset of accessed data, and optionally is retroactively presented or reconstructed/rebuilt data. In interpreting and separating data, a time restraint may be used. When a time restraint is exceeded, accessed data may be output rather than separated and/or reconstructed data.

Accordingly, some embodiments of the present disclosure relate to interpreting and separating audio or other types of data. Such data may include unique elements that are identified and fingerprinted. Element of data that correspond to a selected set of fingerprints, or which are similar to other autonomously or user selected elements within the data itself, may be selected. Selected data may then be output. Optionally, such output is non-destructive in nature in that output may be rebuilt from fingerprints of included data elements, rather than by subtracting out unwanted data elements.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain embodiments that fall within the broad scope of the disclosed subject matter will be rendered in the appended drawings. Understanding that these drawings only depict example embodiments and are not therefore to be considered to be limiting in scope, nor drawn to scale for all embodiments, various embodiments will be described and explained with additional specificity and detail through the use of the accompanying drawings in which:

FIG. 1 is a schematic illustration of an embodiment of a communication system which may be used in connection with data analysis, interpretation and/or separation systems;

FIG. 2 is a schematic illustration of an embodiment of a computing system having which may receive or send information over a communication system such as that depicted by FIG. 1;

FIG. 3 illustrates an embodiment of a method for interpreting and separating elements of a data signal and constructing an output including at least some elements of the data signal;

FIG. 4 illustrates an embodiment of a method for interpreting data to detect commonalities of elements within the data, and separating elements having common features relative to other elements not sharing such common features;

FIG. 5 illustrates an embodiment of a waveform representative of a two-dimensional data signal;

FIGS. 6 and 7 illustrate alternative three-dimensional views of data produced by a transformation of the data of FIG. 5;

FIG. 8 is a two-dimensional representation of the three-dimensional plot of FIGS. 6 and 7;

FIG. 9 illustrates a single window segment that may be identified in the data represented in FIGS. 6-8, the window segment including a fundamental frequency progression and a harmonic of the fundamental frequency progression;

FIG. 10 provides a graphical representation of a single frequency progression within the data represented by FIGS. 5-9, which frequency progression may be defined by data that forms, or is used to form, a fingerprint of the fundamental frequency progression of FIG. 9;

FIG. 11 depicts an embodiment of a window table for storing data corresponding to various window segments of data within a data signal;

FIG. 12A illustrates an embodiment of a global hash table for storing data corresponding to various window segments and fingerprints of data elements within the window segments;

FIG. 12B illustrates an embodiment of a global hash table updated from the global hash table of FIG. 12A to include similarity values indicating relative similarity of fingerprints within a same window segment;

FIG. 12C illustrates an embodiment of a global hash table updated from the global hash table of FIG. 12B to include a reduced number of fingerprints and similarity values indicating relative similarity of fingerprints of different window segments;

FIG. 13 illustrates an embodiment of a fingerprint table identifying a plurality of window segments and including fingerprint data for each window segment, along with data representing the likeness of fingerprints relative to other fingerprints of any window segment;

FIG. 14 illustrates an embodiment of a set table identifying sets of fingerprints, each fingerprint of a set being similar to, or otherwise matching a pattern of, each other fingerprint of the set;

FIG. 15 schematically illustrates an interaction between the tables of FIGS. 11-14;

FIG. 16 illustrates an embodiment of a two-dimensional plot of two sets of elements within the data represented by FIG. 5, and which may be constructed and/or rebuilt to provide an output, either separately or in combination using the methods for interpreting and separating data;

FIG. 17 illustrates a practical implementation of embodiments of the present disclosure in which contact information stored in a contact file on an electronic device includes a set of audio data fingerprints matched to the person identified by the contact file; and

FIG. 18 illustrates an example user interface for a practical application of an audio file analysis application for separating different components of a sound system into sets from a same audio source.

### DETAILED DESCRIPTION

Systems, methods, devices, software and computer-program products according to the present disclosure may be configured for use in analyzing data, detecting patterns or common features within data, isolating or separating one or more elements of data relative to other portions of the data, identifying a source of analyzed data, iteratively building data sets based on common elements, retroactively constructing or rebuilding data, or for other purposes, or for any combination of the foregoing. Without limiting the scope of the present disclosure, data that is received may include analog or digital data. Where digital data is received, such data may optionally be a digital representation of analog data. Whatever the type of data, the data may include a desired data component and a noise component. The noise component may represent data introduced by equipment (e.g., a microphone), compression, transmission, the environment, or other factors or any combination of the foregoing. In the context of a phone call—which is but one application where embodiments of the present disclosure may be employed—audio data may include the voice of a person speaking on one end of the phone call. Such audio data may also include undesired data from background sources (e.g., people, machinery, etc.). Additional undesired data may also be part of the audio component or the noise component. For instance, sound may be produced from vibrations which may resonate at different harmonic frequencies. Thus, sound at a primary or fundamental frequency may be generally repeated or reflected in harmonics that occur at additional, known frequencies. Other information such as crosstalk, reverb, echo, and the like may also be included in either the audio component or noise component of the data.

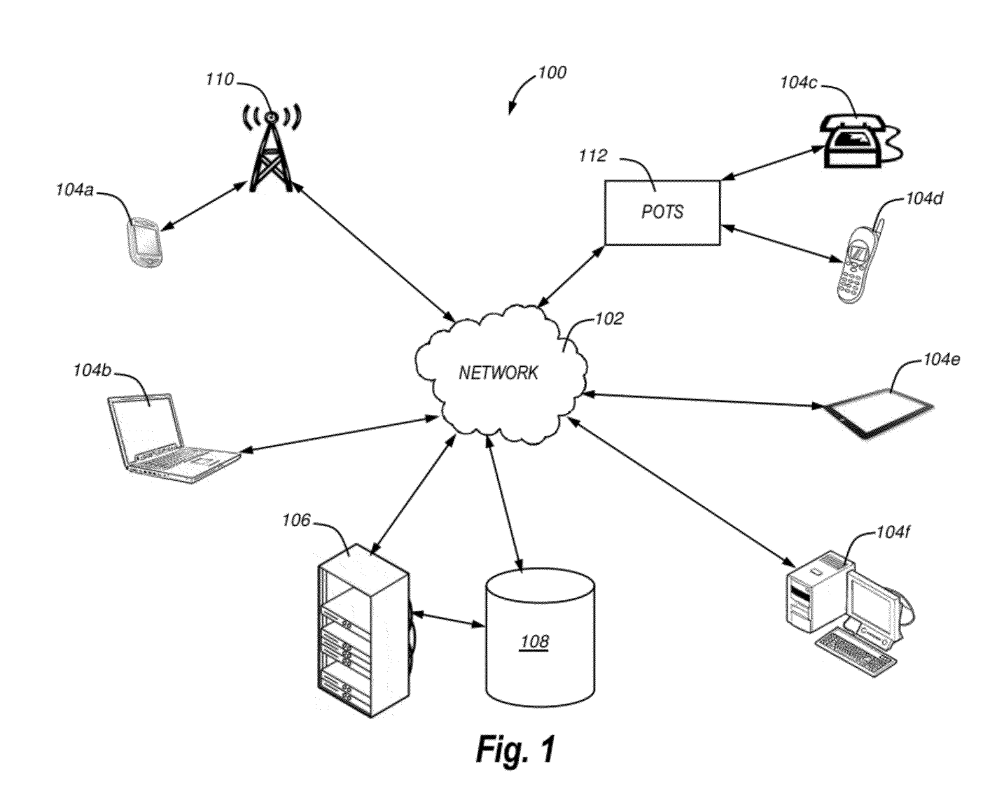

Turning now to FIG. 1, an example system is shown and includes a distributed system 100 usable in connection with embodiments of the present disclosure for analyzing, interpreting and/or separating isolating data. In the illustrated system 100, the operation of the system may include a network 102 facilitating communication between one or more end-user devices 104a-104f. Such end-user devices 104a-104f may include any number of different types of devices or components. By way of example, such devices may include computing or other types of electrical devices. Examples of suitable electrical devices may include, by way of illustration and not limitation, cell phones, smart phones, personal digital assistants (PDAs), land-line phones, tablet computing devices, netbooks, e-readers, laptop computers, desktop computers, media players, global positioning system (GPS) devices, two-way radio devices, other devices capable of communicating data over the network 102, or any combination of the foregoing. In some embodiments, communication between the end-user devices 104a-104f may occur using or in connection with additional devices such as server components 106, data stores 108, wireless base stations 110, or plain old telephone service (POTS) components 112, although a number of other types of systems or components may also be used or present.

In at least one embodiment, the network 102 may be capable of carrying electronic communications. The Internet, local area networks, wide area networks, virtual private networks (VPN), telephone networks, other communication networks or channels, or any combination of the forgoing may thus be represented by the network 102. Further, it should be understood that the network 102, the end-user devices 104a-104f, the server component 106, data store 108, base station 110 and/or POTS components 112 may each operate in a number of different manners. Different manners of operation may be based at least in part on a type of the network 102 or a type of connection to the network 102. For instance, various components of the system 100 may include hard-wired communication components and/or wireless communication components or interfaces (e.g., 802.11, Bluetooth, CDMA, LTE, GSM, etc.). Moreover, while a single server 106 and a single network 102 are illustrated in FIG. 1, such components may be illustrative of multiple devices or components operating collectively as part of the system 100. Indeed, the network 102 may include multiple networks interconnected to facilitate communication between one or more of the end-user devices 104a-104f. Similarly, the server 106 may represent multiple servers or other computing elements either located together or distributed in a manner that facilitates operation of one or more aspects of the system 100. Additionally, while the optional storage 108 is shown as being separate from the server 106 and the end-user or client devices 104a-104f, in other embodiments the storage 108 may be wholly or partially included within any other device, system or component.

The system 100 is illustrative of an example system that may be used, in accordance with one embodiment, to provide audio and/or visual communication services. The end-user systems 104a-104f may include, for instance, one or more microphones or speakers, teletype machines, or the like so as to enable a user of one device to communicate with a user of another device. In FIG. 1, for instance, one or more telephone end-user devices 104c, 104d may be communicatively linked to a POTS system 112. A call initiated at one end-user device 104c may be connected by the POTS system 112 to the other end-user device 104d. Optionally, such a call may be initiated or maintained using the network 102, the server 106, or other components in addition to, or in lieu of, the POTS system 112.

The telephone devices 104c, 104d may additionally or alternatively communicate to a number of other devices. By way of example, a cell phone 104a may make a telephone call to a telephone 104c. The call may be relayed through one or more base stations 110, servers (e.g., server 106), or other components. A base station 110 may communicate with the network 102, the POTS system 112, the server 106, or other components to allow or facilitate communication with the telephone 104c. In other embodiments, the cell phone 104a, which is optionally a so-called “smartphone”, may communicate audio, visual or other data communication with a laptop 104b, tablet computing device 104e, or desktop computer 104f, and do so through the network 102 and/or server 106, optionally in a manner that bypasses the one or more base stations represented by base station 110. Communication may be provided in any number of manners. For instance, messages that are exchanged may make use of Internet Protocol (“IP”) datagrams, Transmission Control Protocols (“TCP”), Hypertext Transfer Protocol (“HTTP”), Simple Mail Transfer Protocol (“SMTP”), Voice-Over-IP (“VoIP), land-line or POTS services, or other communication protocols or systems, or any combination of the foregoing.

In accordance with some embodiments of the present disclosure, information generated or received at components of the system 100 may be analyzed and interpreted. In one embodiment, the data interpretation and analysis is performed autonomously by interpreting data against elements within the data to determine commonalities within elements. Those commonalities may generally define patterns that can be matched with other elements of the data, and then used to separate data among those having common features and those that do not. The manner of detecting commonalities may vary, but in one embodiment can include identifying commonalities with respect to methods and/or rates of change.

As discussed herein, data interpretation and separation, as well as reconstruction of an improved signal, in accordance with embodiments of this disclosure can be used in a wide variety of industries and applications, and in connection with many types of data originating from multiple types of sources. Methods or systems of the present disclosure may, for instance, be included in a telephonic system at end-user devices or at an intermediate device such as a server, base station or the like. Data may, however, be interpreted, separated, reconstructed, or the like in other industries, including on a computing device accessing a file, and may operate on audio, video, image, or other types of data. Thus, merely one example of data that can be interpreted and separated according to embodiments of the present disclosure is audio data, which itself may be received real-time or from storage through a file-based operation. Continuing the example of a telephone call between the cell phone 104 and the telephone 104c, for instance, audio data received at a cell phone 104a may be interpreted by the cell phone 104a, by the telephone 104c, by the POTS 112, by the server 106, by the base station 110, within the network 102, or by any other suitable component. The voice of the caller may be separated relative to sounds or data from other sources, with such separation occurring based on voice patterns of the caller. The separated data may then be transmitted or provided to the person using the telephone 104c. For instance, if the data interpretation and separation occurs at the telephone 104a, the telephone 104a may construct a data signal including the separated voice data and transmit the data to the base station 110 or network 102. Such data may be passed through the server 106, the POTS 112, of other components and routed to the telephone 104c.

Alternatively, the data interpretation and separation may be performed at the base station 110, network 102, server 106, or POTS 112. For instance, data transmitted from the cellular telephone 104a may be compressed by a receiving base station 110. Such compression may introduce noise which can add to noise already present in the signal. The base station 110 can interpret the data, or may pass the signal to the network 102 (optionally through one or more other base stations 110). Any base station 110 or component of the network 102 may potentially perform data interpretation and separation methods consistent with those disclosed by embodiments herein, and thereby clean-up the audio signal. The network 102 may include or connect to the server 106 or POTS 112 which may perform such methods to interpret, separate and/or reconstruct data signals. As a result, data produced by the cell phone 104a can be interpreted and certain elements separated before the data is received by the telephone 104c. In other embodiments, the data received by the telephone 104c may include the noise or other elements and data interpretation and/or separation may occur at the telephone 104c. A similar process may be obtained in any signal generated within the system 100, regardless of the end-user device 104a-104f, server 106, component of the network 102, or other component used in producing, receiving, transmitting, interpreting or otherwise acting upon data or a communication.

Data interpretation and separation may be performed by any suitable device using dedicated hardware, a software application, or a combination of the foregoing. In some embodiments, interpretation and separation may occur on multiple devices, whether making use of distributed processing, redundant processing, or other types of processing. Indeed, in one embodiment any or all of a sending device, receiving device, or intermediary component may analyze, interpret, separate or isolate data.

In an example of a cellular phone communication, for instance, a cell phone 104a may interpret outgoing data and separate the user's voice from background data and/or noise generated by the cell phone 104a. A server 106 or POTS 112 may analyze data received through the base station 110 or network 102 and separate the voice data from background noise, noise due to data compression, noise introduced by the transmission medium, or other noise generated by the cell phone 104a or within the environment or the network 102. The receiving device (e.g., any of end-user devices 104b-104f) may analyze or interpret incoming data, and may separate caller's voice from other noise that may be result from transmission of the data between the network 102 and the receiving device. Thus, the system 100 of FIG. 1 may provide data processing, analysis, interpretation, pattern recognition, separation and storage, or any combination of the foregoing, which is primarily client-centric, which is primarily server or cloud-centric, or in any other manner combining aspects of client or server-centric architectures and systems.

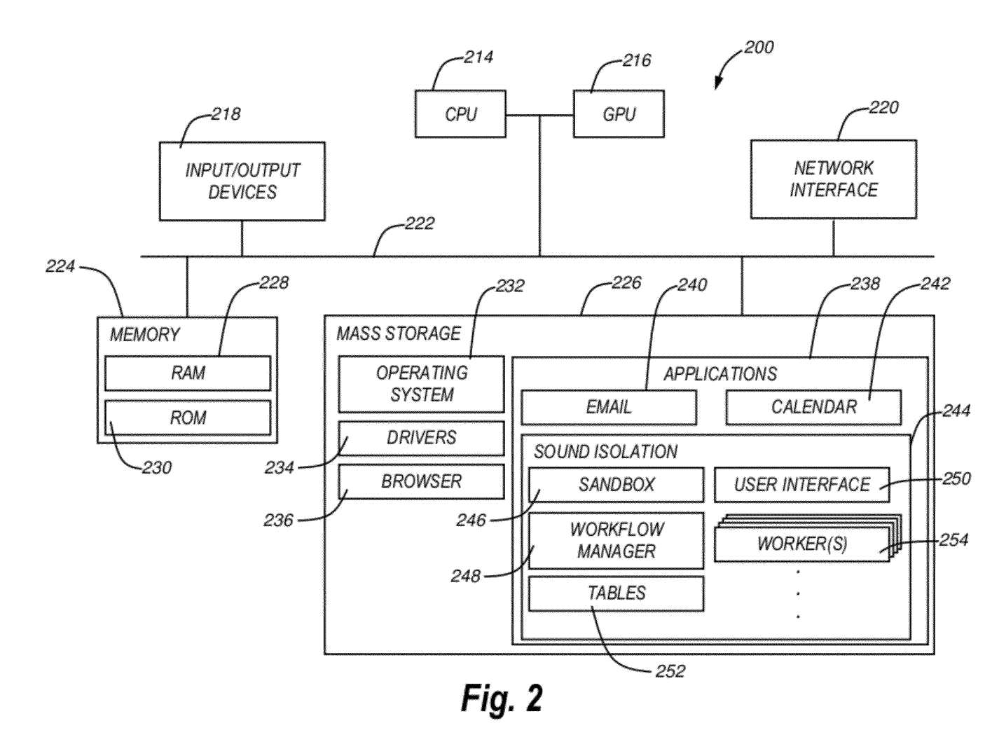

Turning now to FIG. 2, an example of a computing system 200 is illustrated and described in additional detail. The computing system 200 may generally represent an example of one or more of the devices or systems that may be used in the communication system 100 of FIG. 1. To ease the description and an understanding of certain embodiments of the present disclosure, the computing system 200 may at times herein be described as generally representing an end-user device such as the end-user devices 104a-104f of FIG. 1. In other embodiments, however, the computing device 200 may represent all or a portion of the server 106 of FIG. 1, be included as part of the network 102, the base station 110, or the POTS system 112, or otherwise used in any suitable component or device within the communication system 100 or another suitable system. FIG. 2 thus schematically illustrates one example embodiment of a system 200 that may be used as or within an end-user or client device, server, network, base station, POTS, or other device or system; however, it should be appreciated that devices or systems may include any number of different or additional features, components or capabilities, and FIG. 2 and the description thereof should not be considered limiting of the present disclosure.

In FIG. 2, the computing system 200 includes multiple components that may interact together over one or more communication channels. In this embodiment, for instance, the system may include multiple processing units. More particularly, the illustrated processing units include a central processing unit (CPU) 214 and a graphics processing unit (GPU) 216. The CPU 214 may generally be a multi-purpose processor for use in carrying out instructions of computer programs of the system 200, including basic arithmetical, logical, input/output (I/O) operations, or the like. In contrast, the GPU 216 may be primarily dedicated to processing of visual information. In one embodiment, the GPU 216 may be dedicated primarily to building images intended to be output to one or more display devices. In other embodiments, a single processor or multiple different types of processors may be used other than, or in addition to, those illustrated in FIG. 2.

Where a CPU 214 and GPU 216 are included in the system 200, they may each be dedicated primarily to different functions. As noted above, for instance, the GPU may be largely dedicated to graphics and visual-related functions. In some embodiments, the GPU 216 may be leveraged to perform data processing apart from visual and graphics information. For instance, the CPU 214 and GPU 216 optionally have different clock-speeds, different capabilities with respect to processing of double precision floating point operations, architectural differences, or other differences in form, function or capability. In one embodiment, the GPU 216 may have a higher clock speed, a higher bus width, and/or a higher capacity for performing a larger number of floating point operations, thereby allowing some information to be processed more efficiently than if performed by the CPU 214.

The CPU 214, GPU 216 or other processor components may interact or communicate with input/output (I/O) devices 218, a network interface 220, memory 224 and/or a mass storage device 226. One manner in which communication may occur is using a communication bus 222, although multiple communication busses or other communication channels, or any number of other types of components may be used. The CPU 214 and/or GPU 216 may generally include one or more processing components capable of executing computer-executable instructions received or stored by the system 200. For instance, the CPU 214 or GPU 216 may communicate with the input/output devices 218 using the communication bus 216. The input/output devices 218 may include ports, keyboards, a mouse, scanners, printers, display elements, touch screens, microphones or other audio input devices, speakers or audio output devices, global positioning system (GPS) units, audio mixing devices, cameras, sensors, other components, or any combination of the foregoing, at least some of which may provide input for processing by the CPU 214 or GPU 216, or be used to receive information output from the CPU 214 or GPU 216. Similarly, the network interface 220 may receive communications via a network (e.g., network 102 of FIG. 1). Received data may be transmitted over the bus 222 and processed in whole or in part by the CPU 214 or GPU 216. Alternatively, data processed by the CPU 214 or GPU 216 may be transmitted over the bus 222 to the network interface 220 for communication to another device or component over a network or other communication channel.

The system 200 may also include memory 224 and mass storage 226. In general, the memory 224 may include both persistent and non-persistent storage, and in the illustrated embodiment the memory 224 is shown as including random access memory 228 and read only memory 230. Other types of memory or storage may also be included in memory 224. The mass storage 226 may generally be comprised of persistent storage in a number of different forms. Such forms may include a hard drive, flash-based storage, optical storage devices, magnetic storage devices, or other forms which are either permanently or removably coupled to the system 200, or in any combination of the foregoing. In some embodiments, an operating system 232 defining the general operating functions of the computing system 200, and which may be executed by the CPU 214, may be stored in the mass storage 226. Other example components stored in the mass storage 226 may include drivers 234, a browser 236 and application programs 238.

The term “drivers” is intended to broadly represent any number of programs, code, or other modules including Kernel extensions, extensions, libraries, or sockets. In general, the drivers 234 may be programs or include instructions that allow the computing system 200 to communicate with other components either within or peripheral to the computing system 200. For instance, in an embodiment where the I/O devices 218 include a display device, the drivers 234 may store or access communication instructions indicating a manner in which data may be formatted to allow data to be communicated thereto, so as to be understood and displayed by the display device. The browser 236 may be a program generally capable of interacting with the CPU 214 and/or GPU 216, as well as the network interface 220 to browse programs or applications on the computing system 200 or to access resources available from a remote source. Such a remote source may optionally be available through a network or other communication channel. A browser 236 may generally operate by receiving and interpreting pages of information, often with such pages including mark-up and/or scripting language code. In contrast, executable code instructions executed by the CPU 214 or GPU 216 may in a binary or other similar format and be executable and understood primarily by the processor components 214, 216.

The application programs 238 may include other programs or applications that may be used in the operation of the computing system 200. Examples of application programs 232 may include an email application 240 capable of sending or receiving email or other messages over the network interface 220, a calendar application 232 for maintaining a record of a current or future data or time, or for storing appointments, tasks, important dates, etc., or virtually any other type of application. As will be appreciated by one of skill in the art in view of this disclosure, other types of applications 238 may provide other functions or capabilities, and may include word processing applications, spreadsheet applications, programming applications, computer games, audio or visual data manipulation programs, camera applications, map applications, contact information applications, or other applications.

In at least one embodiment, the application programs 238 may include applications or modules capable of being used by the system 200 in connection with interpreting data to recognize patterns or commonalities within the data, and in separating elements sharing commonalities from those that do not. For instance, in one example, audio data may be interpreted to facilitate separation of one or more voices or other sounds relative to other audio sources, according to patterns or commonalities shared by elements found within the data. Like data may then be grouped as being associated with a common source and/or separated from the other data. An example of a program that may analyze audio or other data may be represented by the data interpretation application 244 in FIG. 2. The data interpretation application 244 may include any of a number of different modules. For instance, in the illustrated figure, the data interpretation application 244 may include sandbox 246 and workflow manager 248 components. In some embodiments, the operating system 232 may have, or appear to have, a unified file system. The sandbox component 246 may be used to merge directories or other information of the data interpretation application 244 into the unified file system maintained by the operating system 232, while optionally keeping the physical content separate. The sandbox component 246 may thus provide integrated operation with the operating system 232, but may allow the data interpretation application 244 to maintain a distinct and separate identity. In some embodiments, the sandbox component 246 may be a Unionfs overlay, although other suitable components may also be used.

The workflow manager component 248 may generally be a module for managing other operations within the data interpretation application 244. In particular, the workflow manager 248 may be used to perform logical operations of the application, such as what functions or modules to call, what data to evaluate, and the like. Based on the determinations of the workflow manager 248, calls may be made to one or more worker modules 254. The worker modules 254 may generally be portions of code or other computer-executable instructions that, when run on the computing system 200, operate as processes within an instance managed by the workflow manager 248. For instance, each worker module 254 may be dedicated to performance of a specific task such as data transformation, data tracing, and the like. While the worker modules 254 may perform tasks on data being analyzed using the data interpretation application 244, the workflow manager 248 may determine which worker modules 254 to call, and what data to provide for operations done by the worker modules 254. The worker modules 254 may thus be under the control of the workflow manager 248.

The data interpretation application 244 may also include other components, including those described or illustrated herein. In one embodiment, for instance, the data interpretation application 244 may include a user interface module 250. In general, the user interface module 250 may define a view of certain data. In the context of the data interpretation application 244, for instance, the user interface module 250 may display an identification of certain patterns recognized within a data set, sets of elements within a data set that share certain commonalities, associations of patterns with data from a particular source (e.g., person, machines, or other sources), and the like. The workflow manager 248 may direct what information is appropriate for the view of the user interface 250.

As further shown in FIG. 2, the data interpretation application 244 may also include an optional tables module 252 to interact with data stored in a data store (e.g., in memory 224, in storage 226, or available over a network or communication link). The tables module 252 may be used to read, write, store, update, or otherwise access different information extracted, processed or generated by the data interpretation application 244. For instance, worker modules 254 may interpret received data and identify patterns or other commonalities within elements of the received data. Patterns within the data, the data matching a pattern, or other data related to the received and interpreted data may be stored or referenced in one or more tables managed by the tables module 252. As data elements are identified, similarities between date elements are determined, similar or identical data elements are identified, and the like, tables may be updated using the tables module 252. Optionally, data written by the tables module 252 to one or more tables may be persistent data, although some information may optionally be removed at a desired time (e.g., at a conclusion of a communication session or after a predetermined amount of time).

The various components of the data interpretation application 244 may interact with other components of the computing system 200 in a number of different manners. In one embodiment, for instance, the data interpretation application 244 may interact with the memory 228 to store one or more types of information. Access to RAM 228 may be provided to the worker modules 254 and/or table module 252. As an example, data may be written to tables stored in the RAM 228, or read therefrom. In some embodiments, different modules of the data interpretation application 244 may be executed by different processors. As an example, the GPU 216 may optionally include multiple cores, have a higher clock rate than the CPU 214, a different architecture, or have higher capacity for floating point operations. In at least one embodiment, worker modules 254 may process information using the GPU 216, optionally by executing instances on a per core basis. In contrast, the workflow manager 248 which can operate to logically define how the worker modules 254 operate, may instead operate on the CPU 214. The CPU 214 may have a single core or multiple cores. In some embodiments, the workflow manager 248 defines a single instance on the CPU 214, so that even with multiple cores the CPU 214 may run a single instance of the workflow manager 248.

In some cases, the one or more instances of the worker modules 254 may be contained within a container defined by the workflow manager 248. Under such a configuration, a failure of a single instance may be recovered gracefully as directed by the workflow manager 248. In contrast, in embodiments where the workflow manager 248 operates outside of a similar container, terminating an instance of the workflow manager 248 may be less graceful. By way of illustration, the sandbox component 246 and/or workflow manager 248 may allow the workflow manager 248 or one or more worker modules 254 under the control of the workflow manager 248 to intercept data being transferred between certain components of the computing system 200. For instance, the workflow manager 248 may intercept audio data received over a microphone or from an outbound device, before that information is transmitted to a speaker component, or to a remote component by using the network interface 220. Alternatively, information received through an antenna or other component of the network interface 220 may be intercepted prior to its communication to a speaker component or prior to communication to another remote system. If the workflow manager 248 fails, the ability of the data interpretation application 244 to intercept data may terminate, causing the operating system 232 to control operation and bypass the data interpretation application 244 at least until an instance of the data interpretation application 244 can be restarted. If, however, a worker module 254 fails, the workflow manager 252 may instantiate a new instance of the corresponding worker module 254, but operation of the data interpretation application 244 may appear uninterrupted from the perspective of the operating system.

The system of FIG. 2 is but one example of a suitable system that may be used as a client or end-user device, a server component, or a system within a communication or other computing network, in accordance with embodiments of the present disclosure. In other embodiments, other types of systems, applications, I/O devices, communication components or the like may be included. Additionally, a data interpretation application may be provided with still additional or alternative modules, or certain modules may be combined into a single module, separated from an instance of the workflow manager, or otherwise configured.

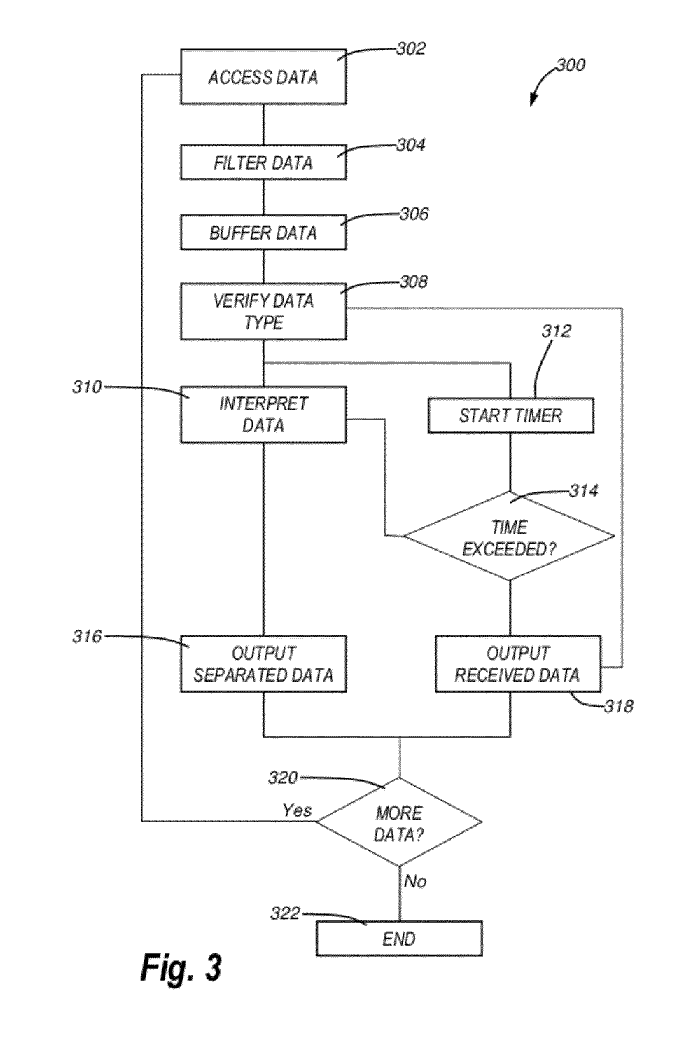

FIG. 3 illustrates an example method 300 for analyzing and isolating data in accordance with some embodiments of the present disclosure. The method 300 may be performed by or within the systems of FIG. 1 or FIG. 2; however, the method 300 may also be performed by or in connection with other systems or devices. In accordance with embodiments of the present disclosure, the method 300 may include receiving or otherwise accessing data (act 302). Accessed data may optionally be filtered (act 304) and buffered (act 306). The type of the data may also be verified (act 308). Accessed data may also be contained and interpreted (step 310), and data separated data may be output (act 316). In some cases, data interpretation and separation may be timed so as to ensure timely delivery of data within a communication session.

More specifically, the method 300 of interpreting and separating data may include an act 302 of accessing data. The data that is accessed in act 302 may be of a number of different types and may be received from a number of different sources. In one embodiment, for instance, the data is received in real-time. For instance, audio data may be received in real-time from a microphone, over a network antenna or interface capable of receiving audio data or a representation of audio data, or from another source. In other embodiments, the data may be real-time image or video data, or some other type of real-time data accessible to a computing device or system. In another embodiment, the received data is stored data. For instance, data stored by a computing system may be accessed and received from a memory or another storage component. Thus, the data received in act 302 may be for use in real-time data operations or in file-based data operations.

The method 300 may include an optional act 304 of filtering the received data. As an illustration, an example may be performed in the context of audio data that is received (e.g., through a real-time or stored audio signal). Such audio data may include information received from a microphone or other source, and may include a speaker's voice as well as noise or other information not consistent with sounds made by a human voice or whatever other type of sound may be expected. It should be appreciated in view of this disclosure that at any instant of time in real-time or stored audio data, sounds or data from different sources may be combined together to form the complete set of audio data. Sounds at the instant in time may be produced by devices, machines, instruments, people, or environmental factors, with many different contributing sounds or other data being provided each at different frequencies and amplitudes.

In one embodiment, filtering the received data in act 304 may include applying a filter capable of removing unwanted portions of data. Where human vocal sounds are desired or expected, for instance, a filter may be applied to remove data not likely to be made by a human voice, thus leaving data within a range possible by a human voice or other desired source of audio. By way of example only, a human male may typically produce sounds having a fundamental frequency between about 80 Hz and about 1100 Hz, while a human female may produce sounds having a fundamental frequency typically between about 120 Hz and about 1700 Hz. In other situations, a human may nonetheless make sounds outside of an expected range of between about 80 Hz and about 1700 Hz, including as a result of harmonics. A full range of frequencies produced by a human male may be in the range of about 20 Hz to about 4500 Hz, while for a female the range may be between about 80 Hz and about 7000 Hz.

In at least one embodiment, filtering data in act 304 may include applying a filter, and the filter optionally includes tolerances to capture most, if not all, human voice data, or whatever other type of data is desired. In at least some embodiments, a frequency filter may be applied on one or both sides of the expected frequency range. As an illustration, a low-end filter may be used to filter out frequencies below about 50 Hz, although in other embodiments there may be no low-end filter or the low-end filter may be to filter out data higher or lower than 50 Hz (e.g., below 20 Hz). A high-end frequency filter may additionally or alternatively be placed on the higher end of the frequency range. For instance, a filter may be used to filter out sounds above about 2000 Hz. In other embodiments, different frequency filters may be used. For instance, in at least one embodiment, a high-end frequency filter may be used to filter out data above about 3000 Hz. Such a filter may be useful for capturing human voice as well as a wide range of harmonics of a human voice and other potential sources of audio data, although a frequency filter may also filter data below or above about 3000 Hz (e.g., above 7000 Hz). In another embodiment where voice data is expected or desired, a filter may simply be used to identify or pass through a desired frequency range, while information outside that range is discarded or otherwise processed. In one embodiment, data may be transformed during the method 300 to have an identified frequency component, and data points having frequencies outside a desired range may be ignored or deleted.

The foregoing descriptions of examples for filtering data in act 304 are merely illustrative. Filtering of data in act 304 is optional and need not be used in all embodiments. In other embodiments where data filtering is used, the data may be filtered at other steps within the method 300 (e.g., as part of verifying data type in act 308 or as part of containing or isolating data in step 310). Accessed data may be filtered according to frequency or other criteria such as audio characteristics (e.g., human voice characteristics). Data filtering in act 304 may, for instance, filter data based on criteria relative to audio data and other types of data, including criteria such as whether data is analog data, digital data, encrypted data, image data, or compressed data.

Data received in act 302 may be stored in a buffer in act 306. The data that is stored in the buffer during act 306 may include data as it is accessed in act 302, or may include filtered data, such as in embodiments where the method 300 includes act 304. Regardless of whether the data is filtered or what type of data is presented, data stored in the buffer may be used for data interpretation, pattern recognition or separation as disclosed herein. In one embodiment, the buffer 306 has a limited size configured to store only a predetermined amount of data. By way of illustration, in the example of a telephone call, a certain amount of data (e.g., 2 MB) or time period for data (e.g., 15 seconds) may be stored in a buffer within memory or other storage. Whether the data is audio data, image data, video data, or other types of data, and whether or not received from a stream, from a real-time source, or even from a file, oldest data may be replaced with newer data. In other embodiments, the data accessed in act 302 may not be buffered. For instance, in a file-based operation, a full data set may already be available, such that buffering of incremental, real-time portions of data may not be needed or desired.

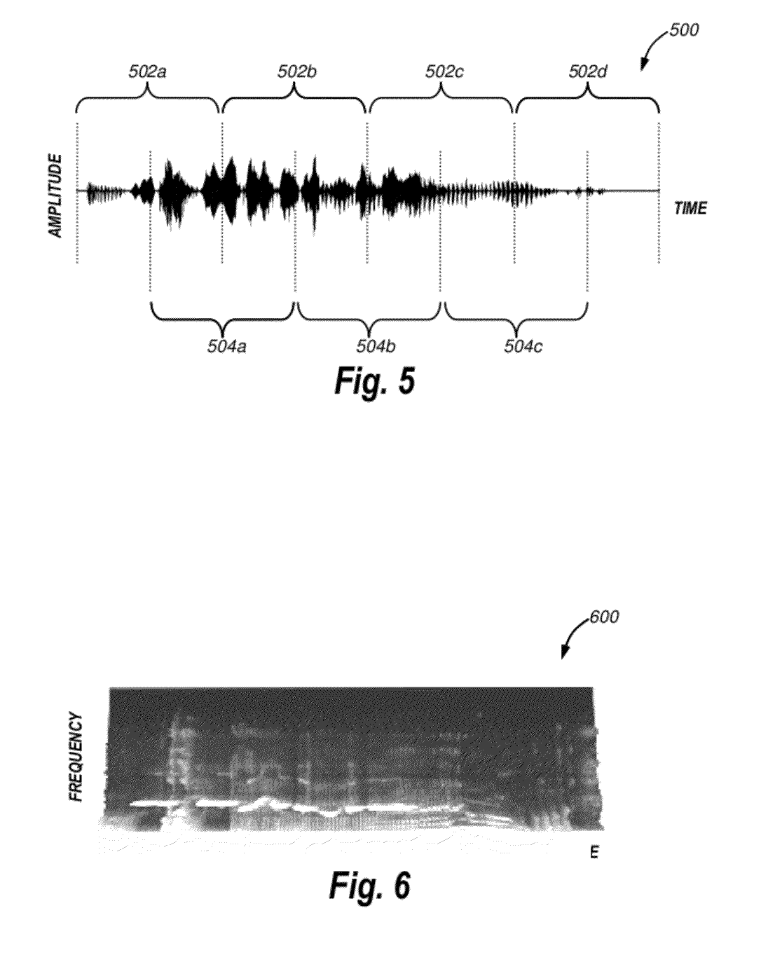

Before or after optional storage of the data in the buffer in act 306, the type of data may be verified in act 308. Such verification process may include evaluating the received data against expected types of data. Examples of data verification may include verifying data is audio data, image data, video data, encrypted data, compressed data, analog data, digital data, other types of data, or any combination of the foregoing. Data verification may also include verifying data is within a subset of a type of data (e.g., a particular format of image, video or audio data, encryption of a particular type, etc.). As an illustration, audio data may be expected during a telephone call. Such data may have particular characteristics that can be monitored. Audio data may include, for instance, data that can generally be represented using a two-dimensional waveform such as that illustrated in FIG. 5, with the two dimensions including a time component and an amplitude (i.e., volume or intensity) component. If the method 300 is looking for other types of data, characteristics associated with that information may be verified.

If the data is evaluated and the verification in act 308 indicates that the data does not conform to a type of data that is expected, the process may proceed to an act 318 of outputting received data. In such an embodiment, corresponding data stored in a buffer (as stored in act 306), file or other location may be passed to a data output component (e.g., a speaker, a display, a file, etc.). Thus, information that is output may generally be identical to the information that is received or otherwise accessed in act 302, and can potentially bypass interpretation in act 310 of method 300. However, if the data verified in act 308 is determined to be of a type that is expected, the data may be passed into a container for separate processing. FIG. 3 illustrates, for example, that verified data may be interpreted in a step 310. Such a step may include interpreting or otherwise processing data to identify patterns and commonalities of elements within the data and/or separating data elements with a particular common feature, pattern or trait relative to all other data elements. Alternatively, the act 310 of containing or isolating data may include interpreting or otherwise processing data, and detecting many different features, patterns or traits within the data. Each separate feature, pattern or trait within the data may be considered, and all elements of the data matching each corresponding pattern, feature or trait can be separated into respective sets of common data elements. More particularly, each set may include data elements of a particular pattern distinguishable from patterns used to build data into other sets of separated data. Thus, data may be separated in act 310 into one data set, two data sets, or any number of multiple data sets.

Once desired data is interpreted, analyzed, separated or otherwise contained or processed in step 310, the data can be output in act 316. This may include outputting real-time data or outputting stored data. In the example of an ongoing telephone call, data output may correspond to the voice of a speaker at one end or the other of the telephone call, with the voice separated from background sounds, noise, reverb, echo, or the like. Output data from a telephone call may be provided to a speaker or a communication component for transfer over a network, and may include the isolated voice of the speaker, thereby providing enhanced clarity during a telephone conversation. A device providing the output, which may include separated and rebuilt or reconstructed data, may include an end-point device, or an intermediate device. In other embodiments, the output data may be of other types, and may be real-time or stored data. For instance, a file may be interpreted and output from the processing of the file may be produced and written to a file. In other embodiments, real-time communications or other data may be output as a file rather than as continued real-time or streamed output. In other embodiments, the data that is output—whether in real-time or to storage—may be data other than audio data.

It will be appreciated that at least in the context of some real-time data communication, including but not limited to telephone or similar communication, processing incoming or outgoing audio data may introduce delays in a conversation. Significant delays may be undesirable. More particularly, modern communication allows near instantaneous delivery of sound, image or video conversations, and people that are communicating typically prefer that communications include as small lag time as possible. If, in the method 300, data is received in real-time, interpreting and processing the data to isolate or separate particular elements could take an amount of time that produces a noticeable lag (e.g., an eight of a second or more, half a second or more), which could be introduced into a conversation or other communication. Such a delay may be suitable for some real-time communications; however, as delays due to processing increase, the quality and convenience of certain real-time data may decrease.

Where a delay introduced by interpreting, separating, reconstructing, rebuilding or otherwise processing data is a concern, the method 300 may include optional measures for ensuring timely delivery of data. Such measures may be particularly useful in real-time data communication systems, but may be used in other systems. A file-based operation may also incorporate certain aspects of ensuring proper or timely delivery of data. As an example, measures for ensuring timeliness of processing applications may be used to enable the method 300 to bypass interpreting or further processing certain data if the data or processing time causes the system performing the method to hang-up or stall at a particular operation, or otherwise delay delivery of data for too long (e.g. beyond a set time threshold).

In some embodiments where the time which data delivery is crucial or important, the method 300 may include a timing operation. Such a timing operation may include initializing a timer in act 312. The timer may be initialized at about the time processing begins to isolate or contain the data in act 310. Alternatively, the timer may be initialized at other times. The timer may, for instance, be started when the data type is verified in act 308, when the data is filtered in act 304, immediately upon receipt or other accessing of the data in act 302, when data is optionally first stored in a buffer in act 306, or at another suitable time.

The timer started in act 312 is optionally evaluated against a maximum time delay. In act 314, for instance, the timer may be measured against the maximum time delay. If the timer has not exceeded the maximum, the method 300 may allow the data interpretation and/or separation in act 310 to continue. Alternatively, if the interpretation and/or separation in act 310 is taking too long, such that the maximum time is exceeded, the determination in act 314 may act to end the act 310 with respect to certain data, or to otherwise bypass such processing. In one example, once a maximum time delay has been exceeded, the method 300 may include obtaining the information stored in the buffer during act 306 and which corresponds to information being interpreted in act 310, outputting the accessed, buffered data instead of outputting the isolated data, as shown in act 318. In embodiments where the data is not buffered, data may be re-accessed from an original or other source and then output to bypass the act 310. When the received data is output, as opposed to the interpreted, separated data, the method 300 may also cause the interpretation process of act 310 to end.

In the optional embodiments where a timer or other timing measure is included, the maximum time delay that is used may be varied, and can be determined or varied in any suitable manner. In one embodiment, the maximum delay may be a fixed or hard coded value. For instance, it may be determined that a delay between about 0 and about 250 milliseconds may be almost imperceptible for a particular type of data. For instance, a delay of about 250 milliseconds may be only barely noticeable in a real-time sound, image or video communication, and thus may not significantly impair the quality of the communication. In that scenario, the time evaluated in act 314 may be based on 250 milliseconds. If the processing in act 310 to interpret and/or separate data is completed before the timer count reaches 250 milliseconds, the isolated data may be output in act 316. However, if the processing in act 310 has not been completed prior to the timer count reaching 250 milliseconds, the processing of act 310 may be terminated and/or the output in act 318 may include the originally received data, which may be obtained from the buffer when present. The timer may, however, vary from 250 milliseconds as such an example is purely illustrative. In other embodiments, for instance, a timer may allow a delay of up to 500 milliseconds, one second, or even more. In other embodiments, the timer may allow a delay of less than 250 milliseconds, less than 125 milliseconds, or some other delay.

In other embodiments, a maximum delay may be larger or smaller than 250 milliseconds. According to at least some embodiments, a time period may be between about 75 milliseconds and about one hour, although greater or smaller time values may be used. As an illustration, a maximum time value of between about 75 and about 125 milliseconds, for instance, may be used to further reduce a perception of any delay in real-time audio, image or video communications.

Regardless of the length of the timer, the value of the timer may be static or dynamic. A particular application may, for instance, be hard-coded to allow a maximum timer of a certain value (e.g., 75 milliseconds, 125 milliseconds, or 250 milliseconds). In other embodiments, the timer length may be varied dynamically. If file size is considered, for instance, a system may automatically determine that a timer used for analyzing a 5 MB file may be much less than a timer for analyzing a 5 GB file. Additionally, or alternatively, a timer value may vary based on other factors, such as the type of data being analyzed (e.g., audio, image, video, analog, digital, real-time, stored, etc.), the type of data communication occurring (e.g., standard telephone, VOIP, TCP/IP, etc.), or other concerns, or any combination of the foregoing.

In the embodiments where a timer and a buffer are both used, the length of the timer may also be related to, or independent of, the size of the buffer. For instance, a 125 millisecond timer could indicate the buffer stores about 125 milliseconds of information and/or that multiple buffers each storing about 125 milliseconds of data are used. In other embodiments, however, the timer may be shorter in time relative to an amount of information stored in the buffer. For instance, a timer of 125 milliseconds may be used even where the buffer holds a greater amount of information (e.g., 250 milliseconds of data, 15 seconds of data, 1 hour of data, etc).

It should be appreciated that in other embodiments, the delay caused by interpretation of real-time data may not be significant. For instance, if the data is not real-time data, but is instead stored data, the time to process the data may not be as significant a consideration. Indeed, even for real-time data delays in processing may not be particularly significant, such as were real-time data is being converted to stored data. For applications which are not time sensitive, the timer may be eliminated, or a timer may be used but can optionally include a larger, and potentially much larger, maximum time delay. For instance, an illustrative embodiment may set a value of one hour, so that if interpretation of a full file is not complete within an hour, the operation may be terminated. In other embodiments, when a timer value is exceeded, a warning may appear to allow a user or administrator to determine whether to continue processing. In another embodiment, if a timer value is exceeded, data being interpreted may be automatically sliced to reduce the volume of data being interpreted at a given time, or a user or administrator may be given the ability to select whether data should be sliced. Regardless of the particular delay, a failsafe data processing system may be provided so that even in the event processing is delayed, communications or other processing operations are not interrupted or delayed beyond a desired amount. Such processing may be used whether the data is real-time data, file-based data, or some other type of data.

As noted herein, information that is analyzed may be used to recognize patterns and commonalities between different elements of the same data set, and data elements matching particular patterns or commonalities may be output in real-time or in other manners. Examples of real-time analysis and output may include streaming audio data over a network or in a telephone call. Real-time data may be buffered, with the buffer storing discrete amounts of the data that are gradually replaced with newer data. As all of the data of a conversation, streamed data, or other real-time data may not be available at a single time, the data analyzed may not include a complete data set, but instead may be broken into smaller segments or slices of time. In such an embodiment, the data that is output in acts 316 and 318 may correspond to the data of individual segments or slices rather than the data of an entire conversation, file or other source.

In a real-time or other data transfer scenario in which data is partially analyzed and output, a determination may be made in act 320 as to whether there is more data to process. Such a determination may occur after separated or otherwise isolated data is stored, output or otherwise determined. Determining whether there is more data to process may include monitoring the communication channel over which data is received or accessed in act 302, by considering whether additional information that has not yet been analyzed is stored in the buffer, if present, or in other manners. Where there is no additional information to interpret, the processing may be concluded and the method 300 can be terminated in act 322. Alternatively, if there is additional data to analyze, the method 300 may continue by receiving or accessing additional data in act 302. Instead of returning to act 302, which may continue at all times during a real-time communication scenario, or even at multiple times in a file-based operation if data is analyzed in pieces rather than a whole, telephone call or other communication, the method may instead return to act 310. In such an act, buffered data 306 may be extracted, contained, analyzed, interpreted, separated, isolated, or otherwise processed. The method 300 may thus be iteratively performed over a length of data so as to separate portions of data to gradually separate data within an entire conversation or other communication.

As discussed herein, the method 300 may be performed on any number of types of different data, and that data may be accessed or otherwise received from any of a number of different sources. For instance, audio data in the form of a telephone call may include receiving audio data using a microphone component. At the receiving telephone, the audio data may be buffered and placed in a container where certain data (e.g., a speaker's voice) may be isolated based on patterns recognized in the data. The isolated data can be output to a communication interface and transmitted to a receiving telephone device. Also within a phone call example, audio data may be analyzed at the receiving device. Such information may be received through an antenna or other communication component. On the receiving device, the sender's voice may be isolated and output to a speaker component. In some embodiments, a single device may selectively process only one of incoming or outgoing audio data, although in other embodiments the device may analyze and process both incoming and outgoing audio data. In still other embodiments, a telephone call may include processing on both sender and/or listener devices, at a remote device (e.g., a server or cloud-computing system), or using a combination of the foregoing. The data being analyzed may also be received or accessed outside of a telephone call setting. For instance, audio data may be received by a hearing aid and analyzed in real-time. Previously generated audio data may also be stored in a file and accessed. In other embodiments, other types of audio or other data may be contained and analyzed in real-time or after generation.

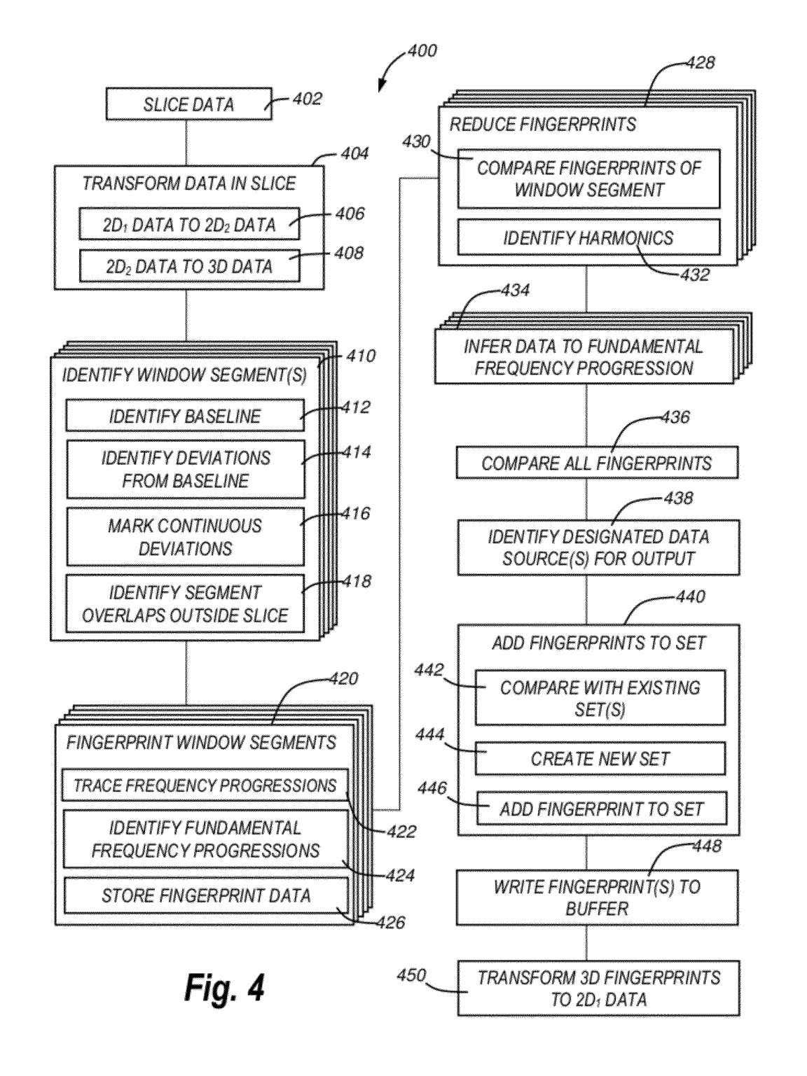

The actual steps or process involved in interpreting and/or separating data, or otherwise processing accessed data, may vary based on various circumstances or conditions. For instance, the type of data being analyzed, the amount of data being analyzed, the processing or computing resources available to interpret the data, and the like may each affect what processing, analyzing, containing or isolating processes may take place. Thus, at least the act 310 in FIG. 3 may include or represent many different types of processes, steps or acts that may be performed. An example of one type of method for analyzing data and detecting patterns within the data is further illustrated in additional detail in FIG. 4.

To simplify a discussion of some embodiments for analyzing data and detecting patterns within the data, the method 400 of FIG. 4 will also be discussed relative to the receipt of real-time audio in a telephone call. Such an example should be understood to be merely illustrative. Indeed, as described herein, embodiments of the present disclosure may be utilized in connection with other real-time audio, delayed or stored audio, or even non-audio information.

The method 400 of FIG. 4 illustrates an example method for analyzing data and detecting patterns, and may be useful in connection with analyzing real-time audio data and detecting and isolating one or more different audio sources within the data. To facilitate an understanding of FIG. 4, reference to certain steps or acts of FIG. 4 may be made with respect to various data types or representations, or data storage containers, such as those illustrated in FIGS. 5-16.

As discussed relative to FIG. 3, data processed according to embodiments of the present disclosure may be stored. For instance, real-time audio information may be at least temporarily stored in a memory buffer, although other types of storage may be used. Where the data is stored in some fashion, the data may optionally be sliced in to discrete portions, as shown in act 402. In the example of a memory buffer storing real-time audio information, the memory buffer may begin storing a quantity of information. Optionally, slicing the audio information in act 402 may include extracting a quantity of audio information that is less than the total amount stored or available. For instance, if the memory buffer is full, slicing the data 402 may include using a subset of the stored information for the process 400. If the memory buffer is beginning to store information, slicing the data in act 402 may include waiting until a predetermined amount of information is buffered. The sliced quantity of data may then be processed while other information is received into the buffer or other data store.

Slices of data as produced in act 402 may result in data slices of a variety of different sizes, or the slices may each be of a generally predetermined size. FIG. 5, for instance, illustrates a representation of audio data. The audio data may be produced or provided in a manner that may be represented as an analog waveform 500 that has two-dimensional characteristics. In FIG. 5, for instance, the two-dimensional waveform 500 may have a time dimension and an amplitude dimension. In other embodiments, the data may be provided or represented in other manners, including as digital data, as a digital representation of analog data, as data other than audio data, or in other formats.

If the data represented by the waveform 500 in FIG. 5 is audio data, the data may be received by a microphone or antenna of a telephone, accessed from a file, or otherwise received and stored in a memory buffer or in another location. Within the context of the method 400 of FIG. 4, the data represented by the waveform 500 may be sliced into discrete portions. As shown in FIG. 5, the data may be segmented or sliced into four slices 502a-502d. Such slices 502a-502d may be produced incrementally as data is received, although for stored data the slices 502a-502d may be created about simultaneously, or slicing the data may even be omitted.

Returning to the method of FIG. 4, slicing of data in act 402 is thus optional in accordance with some embodiments of the present disclosure. The act 402 of slicing data may, for instance, be particularly useful when real-time data is being received. In a telephone call or other real-word or real-time situation, audio data may be continuously produced, and there may not be the opportunity to access all audio data of a conversation or other scenario before the audio data is to be transmitted to a receiving party. In an example where a stored music or other audio file is processed, all information may be available up-front. In that case, data slicing may be performed so that processing can occur over smaller, discrete segments of information, but slicing may be omitted in other embodiments.

Whatever portion of data is analyzed, whether it be a slice of data or a full file or other container of data, the data may be represented in an initial form. As shown in FIG. 5, that form may be two-dimensional, optionally with dimensions of amplitude and time. In other embodiments, two-dimensional data may be obtained in other formats. For instance, data may include a time component but a different second dimensional data value. Other data values for the second dimension may include frequency or wavelength, although still other two-dimensional data may be used for audio, video, image, or other data.

More particularly with regard to the waveform 500 of FIG. 5, the waveform may include time and amplitude data. The time data generally represents at what time one or more sounds occur. The amplitude data may represent what volume or power component is associated with the data at that time. The amplitude data may also represent a combination of sounds with each sound contributing a portion to the amplitude component. In continuing to perform the data analysis and pattern recognition method 400 of FIG. 4, the data represented by the waveform 500 of FIG. 5, or such other data as may be analyzed, may be transformed in step 404. As discussed herein, data that is processed may be within a slice that is a subset of a larger portion of data, with an iterative process occurring to analyze the full data set, although in other embodiments a full data set may be processed simultaneously. Thus, in some embodiments, transforming data in step 404 may include transforming a slice of data (e.g., data within a slice 502a-502d of FIG. 5), or transforming a full data set (e.g., data represented by a waveform of which waveform 500 is a part).

The audio or other type of data may be transformed in a number of different manners. According to one example embodiment, the audio data represented by FIG. 5 may be transformed or converted in act 406 of FIG. 4 from a first type of two-dimensional data to a second type of two-dimensional data. The type of transformation performed may vary, as may the type of dimensions resulting from such a transformation. In accordance with one embodiment, for instance, data may be converted from a time/amplitude domain to a time/frequency domain. In particular, in processing example time/amplitude data, various peaks and valleys can be considered, along with the frequencies of change between peaks and valleys. These frequencies can be identified along with the time at which they occur. Two-dimensional time/frequency information may be produced or plotted in act 406, although data may be transformed in other ways and into other dimensions.

The particular manner in which the transformed data is obtained using act 406 may be varied based on the type of transform to be performed. In accordance with one example embodiment, the transformed data may be produced by applying a Fourier transform to the data represented by the waveform 500 of FIG. 5. An example Fourier transform may be a fractional Fourier transform using unitary, ordinary frequency. In other embodiments, other types of Fourier transforms or other transforms usable in spectral analysis may be used. Where the data is sliced, each slice can be incrementally transformed, such that the slices 502a-502d of data in FIG. 5 can result in corresponding slices within the transformed data. Where the data is not sliced—such as in some file-based operations—the entire data set may be transformed in a single operation.

Transforming the data in act 406, whether using a Fourier transform or another type of transform may provide spectral analysis capabilities. In particular, once transformed, the audio or other data can be represented as smaller, discrete pieces that make up the composite audio data of FIG. 5. Spectral analysis or other data may also be performed in other manners, such as by using wavelet transforms or Kramers-Kronig transforms.

Another aspect of some embodiments of the present disclosure is that transforming the two-dimensional data in act 406 of FIG. 4 may allow a baseline or noise floor to be identified. For instance, if transformed data is in a time/frequency domain, the transformed data may have positive values that deviate from an axis value that may correspond to a frequency of 0 Hz. In real-world situations where audio data is analyzed, there may always be an element of noise in situations where audio data is recorded, stored, transmitted, encrypted, compressed, or otherwise used or processed. Such noise may be due to the microphone used, the environment, electrical cabling, AC/DC conversion, data compression, or other factors. The transformed data may thus show for all time values of a representative time period (e.g., a slice), deviations from a frequency (e.g., 0 Hz). The noise floor may be represented by a baseline that may be a minimum frequency value across the time domain, by a weighted average frequency value over the time domain, by an average or other computation of frequencies when significant deviations from the floor are removed, or in other manners.

The noise floor may also be more particularly identified or viewed if the transformed data produced in act 406 is further transformed into data of three or more dimensions, as shown in act 408 of the method 400 of FIG. 4. In accordance with one embodiment, for instance, where the original and transformed data share a time domain or other dimension, information from the original data may be linked to data in the transformed data. Considering the data represented by the waveform 500, the data may be transformed as described above, and the transformed data may be linked to the data represented by the waveform 500. For corresponding points in time, logical analysis of the data represented by the waveform 500 can be performed to associate an amplitude component with a particular frequency at such point in time. Determined amplitude values can then be added or inferred back into the transformed data, thereby transforming the second, two-dimensional data into three-dimensional data. Although the data referred to herein may at times be referred to as three-dimensional data, it should be appreciated that such terminology may refer to minimum dimensions, and that three, four or more dimensions may be present.

The three-dimensional data may thus be produced by taking data in a time/frequency domain and transforming the data into a time/frequency/amplitude domain, or by otherwise transforming two-dimensional data. In other embodiments, other or additional dimensions or data values may be used. In some embodiments, the three-dimensional data may be filtered. For instance, the filtering act 304 of FIG. 3 may be performed on the three dimensional data. In the example of audio data, for instance, data outside of a particular frequency range (e.g., the range of human sounds), could be discarded. In other embodiments, filtering is performed on other data, is performed in connection with other steps of a method for interpreting and separating data, or is excluded entirely.

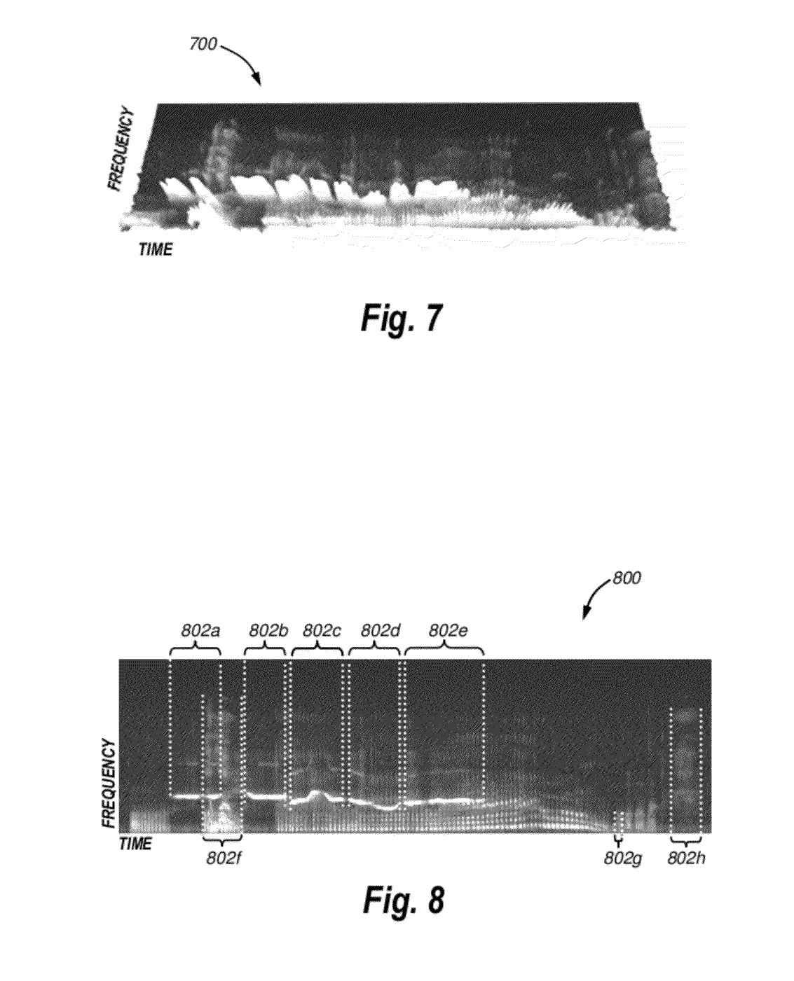

The example three-dimensional data produced in act 408 can be stored or represented in a number of different manners. In one embodiment, the three-dimensional data is optionally stored in memory as a collection of points, each having three data values corresponding to respective dimensions (e.g., time/frequency/amplitude). Such a collection of points can define a point cloud. If plotted, the point cloud may produce a representation of data that can be illustrated to provide an image similar to those of FIG. 6 and FIG. 7, which illustrate different perspectives of the same point cloud data. Plotting or graphically illustrating the three or more dimensions of the data is not necessary to performance of some embodiments of the present disclosure, but may be used for spectral analysis.

Illustrations representing data in three or more dimensions as may be obtained in act 408 by transforming previously transformed, or intermediate data, as shown in FIGS. 6-8. More particularly, FIGS. 6 and 7 illustrate views of a three-dimensional representation 600, 700 in which the model is oriented to illustrate a perspective view of each of the three dimensions. In contrast, FIG. 8 illustrates the three-dimensional representation in two-dimensional space. More particularly, FIG. 8 illustrates the three-dimensional data along two axes. In each of FIGS. 6-8, a third dimension (such as intensity or amplitude), may be illustrated in a different color. Shade gradients may therefore show changes to the magnitude in the third dimension. In one example, such as with audio data, the two dimensions represented in FIG. 8 may be time and frequency, with intensity/amplitude reflected by changes to shade. In grayscale, the lighter the shade, the larger the third dimension (e.g., amplitude), and darker shades may indicate where points of the point cloud have lower relative magnitudes.

When the data has been transformed into three-dimensional data, the method 400 may continue by identifying one or more window segments as shown in step 410. More particularly, step 410 may potentially include any number of parallel or simultaneous processes or instances. Each instance may, for instance, operate to identify and/or act upon a different window segment within a set of data.

Window segments may be generally understood to be portions of data where there are significant, continuous deviations from a baseline (e.g., an audio noise floor). The window segments represent three-dimensional data and thus incorporate points or other data in the time, frequency and amplitude domains of an audio sample, or in other dimensions of other types of data. As window segments may be described as deviations from a baseline, one aspect of the step 410 of identifying window segments may include an act 412 of identifying the baseline. As best seen in the three-dimensional data as represented in FIGS. 6 and 7, the three-dimensional data may have different peaks or valleys relative to a more constant noise floor or other baseline, which has a darker color in the illustration. The noise floor may generally be present at all portions of the three-dimensional data and can correspond to the baseline identifiable from the data produced in act 406. With respect to audio data, the noise floor may represent a constant level of radiofrequency, background, or other noise that is present in the audio data as a result of the microphone, transmission medium, background voices/machines, data compression, or the like. The baseline may be a characteristic of the noise floor, and can represent a pointer or value representing an intensity value. Values below the baseline may generally be considered to be noise, and data below the baseline may be ignored in some embodiments. For data other than audio, a baseline may similarly represent a value above which data is considered relevant, and below which data may potentially be ignored.

With an identified baseline, deviations from the baseline can be identified in act 414. In the context of audio data, deviations from the baseline, particularly when significant, can represent different sources or types of audio data within an audio signal, and can be identifiable as different than general noise below the baseline. These deviations may continue for a duration of time, across multiple frequencies, and can have varying amplitude or intensity values. Each deviation may thus exhibit particular methods and rates of change in any or all of the three dimensions of the data, regardless of what three dimensions are used, and regardless of whether the data is audio data, image data, or some other type of data. Where these deviations are continuous, the method 400 may consider the deviations to be part of a window segment that is optionally marked as shown in act 416.

Identifying and marking deviations in acts 414, 416 may be understood in the context of FIG. 8, where a plurality of window segments 802a-802h are illustrated. FIG. 8 may have many more window segments; however, to avoid unnecessarily obscuring the disclosure, only eight window segments 802a-802h are shown. The window segments 802a-802h may each include clusters of data points that are above the noise floor. Such clusters of data points may also be grouped so that a system could trace or move from one point above the noise floor and in the window segment to another without being required to traverse over a point below the baseline. If to move from one point to another of the point cloud would require that a there be a traversal across points at or below the baseline, the deviations could be used to define different window segments.

When continuous three or more dimensional data points are identified as deviating from the baseline in act 414, the windows containing those deviations may be marked. For instance, the window segment 802c of FIG. 8 may be marked by identifying a time at which the window begins (e.g., a time when a deviation from the baseline begins) and a time when the window segment ends (e.g., a time when a deviation drops back to the noise floor). Where FIG. 8 is representative of audio data having time, frequency and amplitude dimensions, the window start time may be generally constant across multiple frequencies within the same window segment. The same may also be true for the end time of the segment. In other embodiments, however, a window segment may span multiple frequencies and the data points may drop into, or rise from, the baseline at different times within that window. Indeed, in some embodiments, a window segment may begin with a significant deviation spanning multiple frequencies of audio data, but over the time dimension of the window segment, there may be separations and different portions may drop into the noise floor. However, because the points of the progression may be traced to the beginning of the window segment and remain above the noise floor, they can all be part of the same window segment where the data is continuous at the start time.

In marking the window segment, one embodiment may include marking the start time of the window segment. The end time may also be marked as a single point in time corresponding to the latest time of the continuous deviation from the baseline. Using the time data, all frequencies within a particular time window may be part of the same window segment. The window segment may thus include both continuous deviations and additional information such as noise or information contained in overlapping window segments, although the continuous deviation used to define a window segment may primarily be used for processing as discussed hereafter.

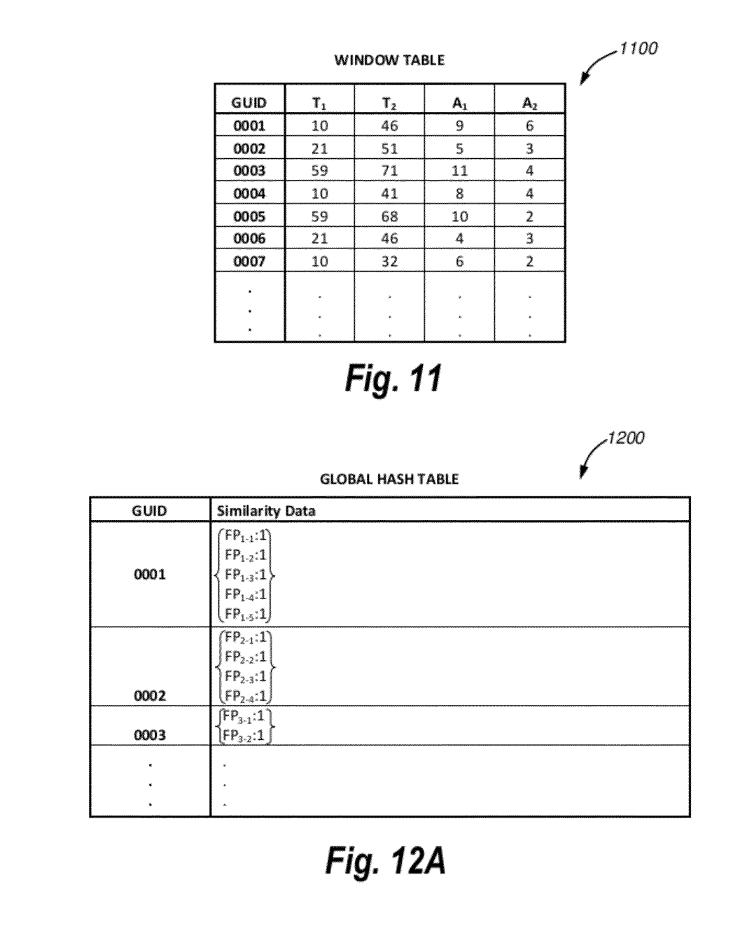

Multiple window segments may be identified in step 410, and such window segments may overlap or be separated. Identification of the window segments may occur by executing multiple, parallel instances of step 410, or in other manners. When each window segment is potentially identified by recognizing deviations from the baseline, such window segments may be marked in act 416 in any number of manners. In one embodiment, rather than using each instance of step 410 to mark a data file itself, a table may be created and/or updated to include information defining window segments. An example of such a table is illustrated in FIG. 11. In particular, FIG. 11 may define a window table 1100 with markers, pointers, or information usable to identify different window segments. In the particular table 1100 illustrated, for instance, each window segment may be identified using a unique identification (ID). The ID may be provided in any number of different forms. For simplicity, the illustration in FIG. 11 shows IDs as incrementing, numerical IDs. In other embodiments, however, other IDs may be provided. An example of a suitable ID may include a globally unique identifier (GUID), examples of which may be represented as thirty-two character hexadecimal strings. Such identifications may be randomly generated or assigned in other manners. Where randomly assigned, the probability of randomly generating the same number twice may approach zero for a thirty-two character GUID due to the large number of unique keys that may be generated.

The window table 1100 may also include other information for identifying a window segment. As shown in FIG. 11, a window table may include the start time (T₁) and the end time (T₂) for a window segment. The data values corresponding to T₁ and T₂ may be provided in absolute or relative terms. For instance, the time values may be in milliseconds or seconds, and provided relative to the time slice of which they are a part. Alternatively, the time values may be provided relative to an entire data file or data session. In some embodiments, an amplitude (A₁) at the start of a window segment may be identified as well. Optionally, an ending amplitude (A₂) of a window segment could also be noted. In some cases, the ending amplitude (A₂) may represent an amplitude of data dropping back to the baseline. This example notation may be useful in other steps or acts of the method 400 of FIG. 4, as well as in identifying the continuous deviation above the baseline and which is used to set the window segment. In accordance with some embodiments, the window table 1100 may also include other information. By way of example, the window segment 1100 may indicate a minimum and/or maximum frequency of a window segment to further mark continuous deviations and/or define a window segment over a limited frequency range.

As should be appreciated in view of the disclosure herein, particularly in embodiments in which data is sliced into discrete portions in act 402, a window segment may not always be neatly contained within a particular data slice. That is to say that a sound or other component of a data signal may start before a particular slice ends, but terminate after such a slice ends. To account for such a scenario, one embodiment of the present disclosure includes identifying window segment overlaps that may exist outside of a given slice (act 418). Identifying such window segments may occur dynamically. For instance, if a window segment has an end time equal to the end of the time slice, a computing system executing the method 400 may access additional data stored in a data buffer, transform the data 404, and process the data to identify window segments in step 410. In such processing, window segments having corresponding deviations in the three-dimensional domain may then be matched with continuous deviations from the original time slice, and can be grouped together.

It is not necessary, however, that window segment overlaps of act 418 be identified, or that if they are identified that identification of overlaps be performed. For instance, in another embodiment, data received and processed using the method 400 may include slicing data 402 into overlapping slices. FIG. 5, for instance, illustrates various slices 502a-502d, each of which may overlap with additional time slices 504a-504c. The overlapping time slices may be concurrently processed. Thus, as window segment identification of step 410 of FIG. 4 occurs, the act 418 of identifying segment overlaps 418 may be initiated automatically by using overlapping data already in process.

Although FIG. 5 illustrates overlaps of about half a time slice, it should be appreciated that such an overlap is merely illustrative. In other embodiments, overlaps may be larger or smaller. In at least one embodiment, for instance, three or more overlapping segments may be present within a single time slice. For instance, relative to two, sequential time slices, an overlapping time slice may overlap two-thirds of the first sequential time slice, and one-third of the second sequential time slice. In other embodiment, any given time slice may overlap with more than three time slices.

By performing multiple instances of step 410, multiple different window segments may be identified within a particular time slice or file, depending on how the data is processed. Upon such identification, the data in the window segments can be further analyzed to identify one or more frequency progression(s) within each window segment. This may occur through a step 420 of fingerprinting the window segments. Fingerprinting the window segments in step 420 may interpret the data in a window segment and separate one or data points. For instance, a primary or fundamental data source for a window segment may be identified as a single frequency progression. As also shown in FIG. 4, the step 420 of fingerprinting window segments may be simultaneously performed for multiple window segments, and multiple fingerprints may be identified or produced within a single window segment.

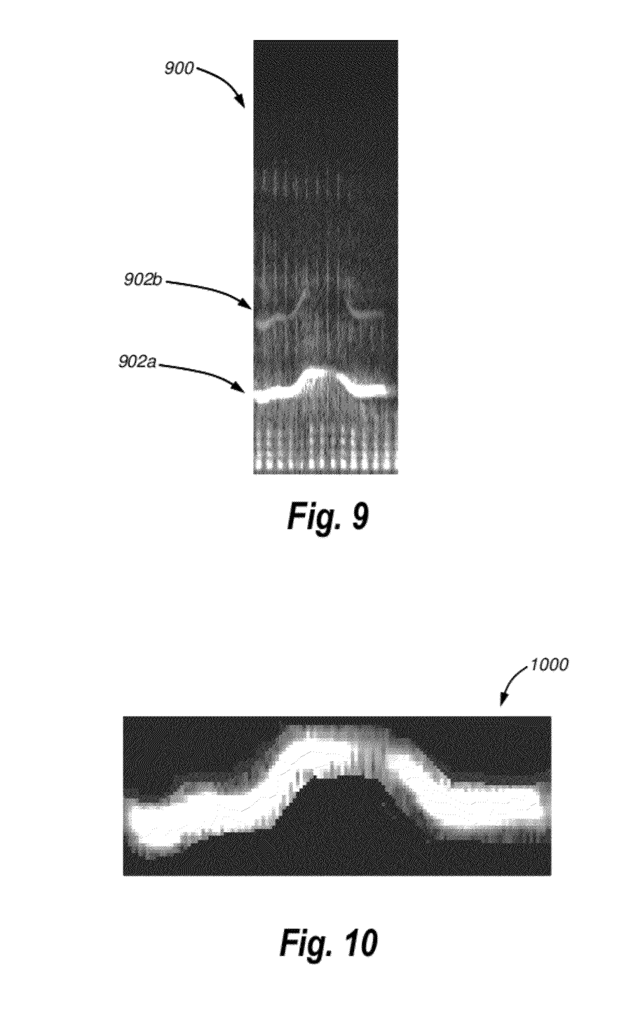

Once the window segments have been identified, the data can be interpreted. One manner of interpreting the data may include identifying data and the corresponding methods and/or rates of change of the data. This may better be understood by reviewing the graphical representation 900 of FIG. 9. The illustration in FIG. 9 generally provides an illustration representing the three-dimensional data of one window segment 802c of FIG. 8, and may include one or more continuous frequency progressions therein. As shown in such a figure, the point cloud data, when illustrated, may be used to view a particular, distinct path across three dimensions (e.g., time, amplitude and frequency). Each frequency progression may have unique characteristics that when represented graphically may be shown as each frequency progression having different shapes, waveforms, or other characteristics. In one embodiment, a tracing function may be called (e.g., when a workflow manager calls a worker module as illustrated in FIG. 2), and one or more paths may be traced across portions of a window segment. Such paths may generally represent different frequency progressions within the same window segment, and tracing the paths may be performed as part of act 422.

In some cases, a single frequency progression may be found in a window segment, although multiple frequency progressions can also be found. In at least one embodiment, multiple frequency progressions may be identified in a window segment. FIG. 9, for instance, illustrates two frequency progressions 902a and 902b which may be within the same window segment and can even start at the same time, or at about the same time. In some cases, when multiple frequency progressions are identified, a single frequency progression can be isolated within the window segment. For instance, a fundamental or primary frequency progression may be identified in act 424. Such identification may occur in any of a number of different manners. By way of example, a frequency progression may be considered as the fundamental frequency progression if it has the largest amplitude and starts at the beginning of a window segment. Alternatively, a fundamental frequency progression may be the progression having the largest average amplitude. In other embodiments, the fundamental frequency progression may be identified by considering other factors. For instance, the frequency progression at the lowest frequency within a continuous deviation from the baseline may be the fundamental frequency progression. In another embodiment, the frequency progression having the longest duration may be considered the fundamental frequency progression. Other methods or combinations of the foregoing may also be used in determining a fundamental frequency progression in act 424. In FIG. 9, the frequency progression 902a may be a fundamental frequency and can have a higher intensity and lower frequency relative to the frequency progression 902b.

With the various frequency progressions within a window segment identified, fingerprint data may be determined and optionally stored for each progression, as shown in act 426. In one embodiment, storing fingerprint data in act 426 may include storing point cloud data corresponding to a particular frequency progression. In other embodiments, act 426 may include hashing point cloud data or otherwise obtaining a representation or value based on the point cloud data of the frequency progression.

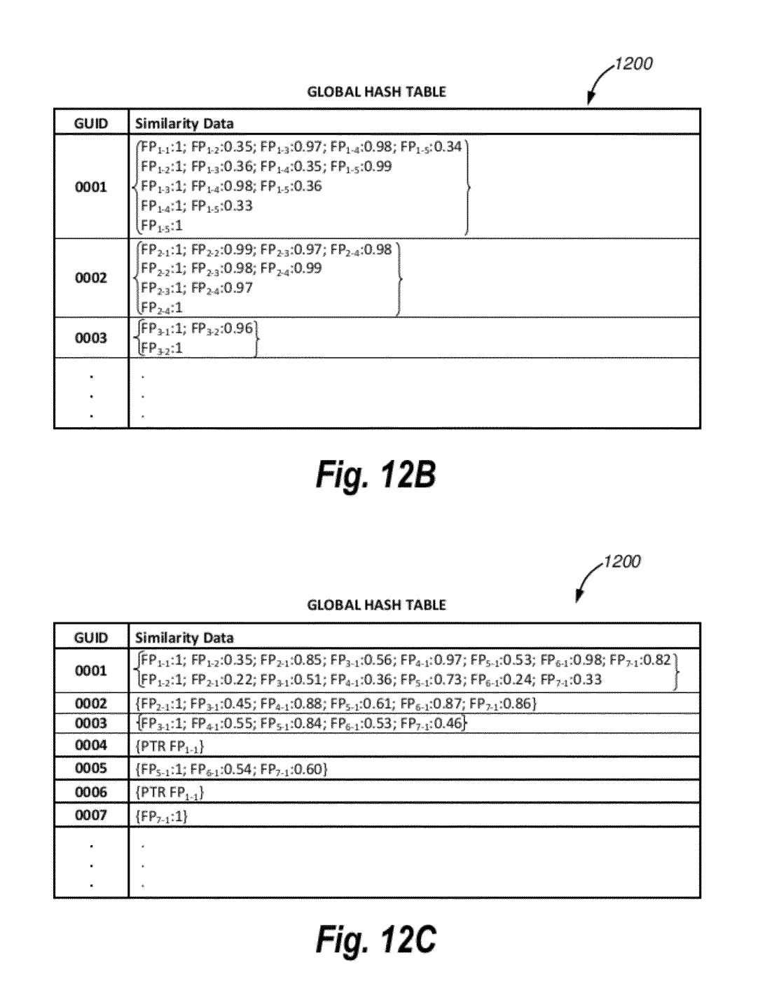

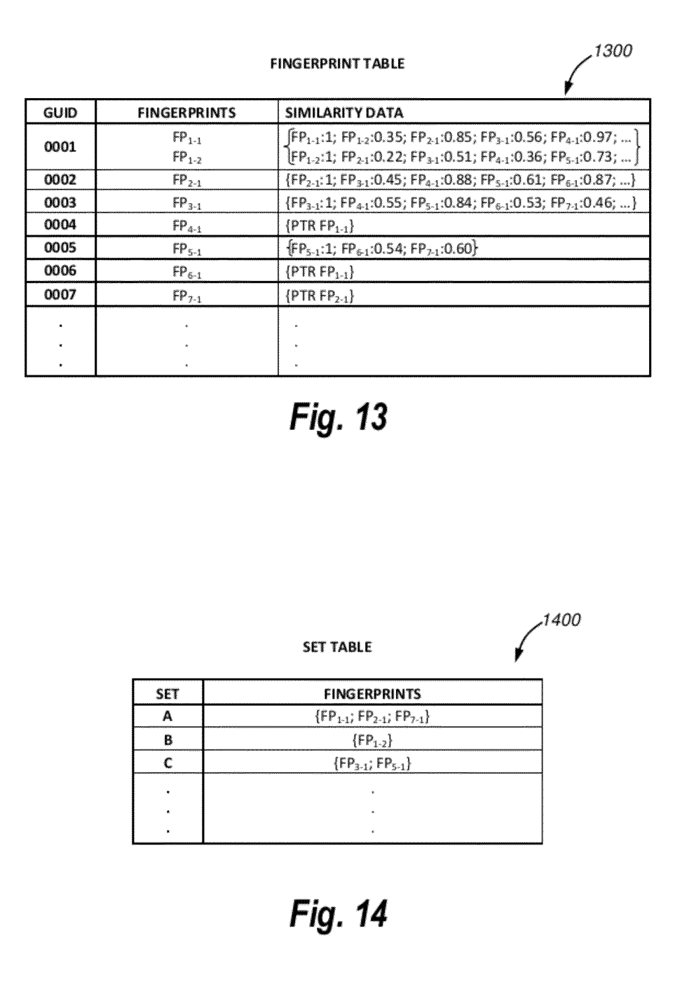

The fingerprint data may be stored in any number of locations, and in any number of manners. In at least one embodiment, a table may be maintained that includes fingerprint information for the window segments identified in act 410. FIGS. 12A-13, for instance, illustrate example embodiments of tables that may store fingerprint and/or window segment information. The table 1200 of FIG. 12A may represent a table that stores information about each fingerprint initially identified as corresponding to a unique frequency progression. For instance, as shown in FIG. 12A, the table 1200 may be used to store information identifying three or more window segments within data that is being analyzed. As frequency progressions are traced or otherwise identified, the data corresponding to those frequency progressions may be considered to be fingerprints. Each fingerprint and/or window segment may be uniquely identified. More particularly, each window segment may be identified using an ID, which ID optionally corresponds to the ID in the window table 1100 of FIG. 11. Accordingly, each window segment uniquely identified in the window table 1100 may have a corresponding entry in the table 1200 of FIG. 12.

In addition, each fingerprint identified or produced in the step 420 can optionally be referenced or included in the table 1200. In FIG. 12A, for instance, a similarity data section is provided. Each fingerprint for a window segment may have a corresponding value or identifier stored in the similarity data, along with an indication that the fingerprint is equal to itself. For instance, if in window segment 0001 the first fingerprint for a window segment is identified as FP₁₋₁, an entry in a data set or array may indicate that the fingerprint is equal to itself. In this embodiment, for instance, likeness may be represented with a value between 0 and 1, where 0 represents no similarity and 1 represents an identical, exact match. The text “FP₁₋₁:1” in an array or other container corresponding to the window segment 0001 may indicate that fingerprint FP₁₋₁ is a perfect match (100%) with itself. For convenience in referring to the table 1200, such a table may be referred to herein as a “global hash table,” although no inference should be drawn that the table 1200 must include hash values or that any values or data in the table are global in nature. Rather, the global hash table may be global in the sense that data from the hash table may be used by other tables disclosed herein or otherwise learned from a review of the disclosure hereof.

The data in table 1200 of FIG. 12A may be modified as desired. In some embodiments, for instance, as additional window segments and/or fingerprints are identified, the table 1200 can be updated to include additional window segments and/or fingerprints. In other embodiments, additional information may be added, or information may even be removed. Accordingly, according to some embodiments, the fingerprint data may be stored, as shown in act 426 of FIG. 4. In at least one embodiment, fingerprint data may be stored in the global hash table 1200 of FIG. 12A, although in other embodiments fingerprint data may be stored in other locations. For instance, fingerprint data may be stored in a fingerprint table 1300 shown in FIG. 13, which table is described in additional detail hereafter.

After producing the various window segments and fingerprints, the method 400 may include a step of reducing the fingerprints 428. In at least one embodiment, reducing the fingerprints 428 may include an act 430 of comparing fingerprints within the same window segment.

More particularly, once frequency progressions within a window segment have been identified (e.g., by producing a fingerprint thereof), the methods and rates of change within a frequency progression may be traced or otherwise determined for comparison to other frequency progressions within the same window segment. Optionally, comparing the frequency progressions includes comparing the fingerprints and determining a likeness value for each fingerprint. Any scale or likeness rating mechanism may be used, although in the illustrated embodiments a likeness value may be determined on a scale of 0 to 1, with 0 indicating no similarity and 1 indicating an identical match.

The likeness data for fingerprints common to a particular window segment may be identified and stored. For instance, FIG. 12B illustrates the global hash table 1200 of FIG. 12A, with the table being updated to include certain likeness data. In this embodiment, a first window segment associated with ID 0001 is shown as having five fingerprints associated therewith. Such fingerprints are identified as FP₁₋₁ to FP₁₋₅. A second window segment is shown as having four identified fingerprints, and a third window segment is shown as having two identified fingerprints.

Within each window segment, the fingerprints may be compared. Fingerprint FP₁₋₁, for instance, can be compared to the other four fingerprints. A measure of how similar such fingerprints are in terms of method and/or rate of change may be stored in the similarity portion of the global hash table 1200. In this embodiment, for instance, an optional array—and optionally a multi-dimensional array—may store a likeness value for each fingerprint relative to each other fingerprint in the same window segment. As a result, FIG. 12B illustrates an array showing similarity values for fingerprint FP₁₋₁ relative to all other fingerprints in the same window segment. Fingerprints FP₁₋₂ through FP₁₋₅ may each be iteratively compared to obtain a likeness value, although once a comparison has been performed between two fingerprints, it does not need to be repeated. More particularly, in iterating over fingerprints and comparing them to other fingerprints, a comparison between two fingerprints need only occur and/or be referenced a single time. For instance, if fingerprint FP₁₋₅ is compared to fingerprint FP₁₋₃, fingerprint FP₁₋₃ does not then need to be compared to fingerprint FP₁₋₅. The results of a single comparison may optionally be stored once. In table 1200 of FIG. 12B, for instance, the comparison between fingerprints FP₁₋₃ and FP₁₋₅ may produce a similarity value of 0.36, and that value can be found in the portion of the array corresponding to fingerprint FP₁₋₃. Thus, the illustrated arrays have reduced information as comparisons of subsequent fingerprints to earlier fingerprints need not be performed or redundantly stored.

The likeness data generated by comparing the fingerprints in act 430 may represent commonalities between different fingerprints, and those commonalities may correspond to similarities or patterns. Example patterns may include similarities with respect to the methods and/or rates in which values change in any of the three dimensions. For an example of audio data, for instance, the frequency and/or amplitude may vary over a particular data fingerprint, and the manner in which those variations occur may be compared to frequency and/or amplitude changes of other data fingerprints.

As data is compared, fingerprints meeting one or more thresholds or criteria may be determined to be similar or even identical. By way of example, in the described example where likeness data is measured relative to a scale between 0 and 1, data having likeness values above a certain threshold (e.g., 0.95) may be considered to be sufficiently similar to indicate that the data is in fact the same, despite occurring multiple times. Thus, as shown in FIG. 12B, likeness values indicate that fingerprint FP₁₋₁ has a likeness value of 0.97 relative to fingerprint FP₁₋₃ and a likeness value of 0.98 relative to fingerprint FP₁₋₄. Similarly, fingerprint FP₁₋₂ is shown as having a likeness value of 0.99 relative to fingerprint FP₁₋₅.

When data is identical, or sufficiently similar to be treated as identical, the multiple fingerprints may be reduced to avoid redundancy. Within global hash table 1200 of FIG. 12B, for instance, fingerprints FP₁₋₃ and FP₁₋₄ may be eliminated as they may be considered identical to fingerprint FP₁₋₁. Fingerprint FP₁₋₅ may also be eliminated if identical to fingerprint FP₁₋₂. Through a similar process, fingerprints FP₂₋₂ through FP₂₋₄ and FP₃₋₂ may be eliminated as they can be considered to be identical relative to fingerprints FP₂₋₁ and FP₃₋₁, respectively. FIG. 12C shows an example global hash table 1200 following reduction of identical fingerprints, and which includes in this embodiment only two fingerprints for window segment 0001, and one fingerprint for each of window segments 0002 and 0003. In some embodiments, the fingerprint(s) retained are those which correspond to fundamental frequencies within a window segment.

Although the foregoing description includes an embodiment for eliminating sufficiently similar fingerprints, other embodiments may take other approaches. For instance, similar fingerprints may be grouped into sets, or pointers may be provided back to other, similar fingerprints. In other embodiments, all information for fingerprints, regardless of similarity, can be retained.

Additionally, the particular threshold value or criteria used to determine which data fingerprints are identical, or sufficiently similar to be treated as identical, or the method of determining likeness, may differ depending on various circumstances or preferences. For instance, the threshold used to determine a requisite level of similarity between fingerprints may be hard coded, may be varied by a user, or may be dynamically determined. For instance, in one embodiment, a window segment may be analyzed to identify harmonics, as indicated in act 432. Generally speaking, sound at a given frequency may resonate as specific additional frequencies and distances. The frequencies where this resonance occurs are known as harmonic frequencies. Often, the methods and rates of change of audio data at a harmonic frequency are similar to those of a fundamental frequency, although the scale may vary in one or more dimensions. Thus, frequency progressions and fingerprints of harmonics may be similar or identical for certain audio data.

Often, harmonic frequency progressions are manifested within the same window segment. In one example embodiment, a fundamental frequency progression may be determined, and the fingerprint of that data can be compared relative to data that may exist at other frequencies within the data segment. If a fingerprint exists for data at a known harmonic frequency, that harmonic data may be removed, grouped in a set, or referenced with a pointer to the fundamental frequency progression, as disclosed herein. In some cases, if the likeness value is not up to a determined threshold, the threshold may optionally be dynamically modified to allow harmonics to be grouped, eliminated, or otherwise treated as desired.

Determining a likeness between fingerprints of different frequency progressions may be used as a technique for pattern recognition within audio or other data, and can in effect be used to determine commonalities that exist between data elements. Such elements may be in the same data, although commonalities may also be determined relative to elements of different data sets as described hereafter.

Likeness values, commonalities, or other features may be determined using any number of different techniques, each of which may be suitable for various different applications. In accordance with one embodiment of the present disclosure, an edge overlay comparison may be used to identify commonalities between different data elements. As part of the edge overlay comparison or another comparison mechanism, the data points corresponding to one fingerprint or frequency progression may be compared to those corresponding to another fingerprint or frequency progression. For instance, an act 430 of comparing fingerprints may attempt to overlay one frequency progression over another. A frequency progression can be stretched or otherwise scaled in any or all of three dimensions to approximate an underlying frequency progression. When such scaling is performed, the resulting data can be compared and a likeness value produced. The likeness value can be used to determine a relative similarity between the manners and rates of change within two fingerprints. If the likeness value is over a particular threshold, data may be considered similar or considered to be identical. Identical data may be grouped together or redundancies eliminated as discussed herein. Data that is considered similar but not above a threshold to be considered identical may also be eliminated or grouped, or may be treated in other manners as discussed herein.

An edge overlay or other comparison process may compare an entire frequency progression, or may compare portions thereof. For instance, a frequency progression may have various highly distinct portions. If those portions are identified in other frequency progressions, the highly distinct portions may be weighted higher relative to other portions of the frequency progression, so that the compared fingerprints produce a match sufficient to allow fingerprints to be eliminated, grouped, or otherwise used. When an edge overlay or other comparison does not find a match, such as when stretching or otherwise scaling a fingerprint in any or all of three dimensions does not produce a likeness value above a threshold, the fingerprint may be considered to be its own set or sample as the data element may have unique characteristics not sufficiently similar to characteristics (e.g., rates or methods of change to data elements) of other fingerprints.

It should be appreciated in view of the disclosure herein that some embodiments may produce multiple fingerprints per window segment, although in operation many window segments may result in a single fingerprint for a window segment. In other embodiments, a reduction of the fingerprints in step 428 may optionally include reducing fingerprints to a single fingerprint, either by eliminating like fingerprints, grouping like fingerprints as a set, or including pointers to a fundamental fingerprint or frequency progression for the corresponding window segment. Multiple fingerprints within a single window segment may also be considered non-similar and exist. For instance, two frequency progressions having the same start and end times may intersect. In such a case, a tracing function may trace the different frequency progressions, and at a location where the progressions cross, an unexpected spike in amplitude may be observed. Traced fingerprints may thus be treated separately while remaining identified within a single window segment. In other embodiments, where multiple, dissimilar frequency progressions are identified in a single window segment, a dominant segment may be obtained and the other(s) eliminated, or new window segment identifiers may be created in the window table 1100 of FIG. 11, the global hash table 1200 of FIGS. 12A-C, and/or the fingerprint table 1300 of FIG. 13, so that each window segment has a single fingerprint corresponding thereto.

It should be appreciated in view of the disclosure herein that comparing fingerprints corresponding to frequency progressions within a window segment, identifying harmonic progressions corresponding to a fundamental frequency progression, and/or identifying similar or identical fingerprints may simplify processing during the method 400. For instance, where the method 400 iterates over multiple fingerprints and window segments, eliminating or grouping fingerprints can reduce the number of operations to be performed, such as later comparisons to additional fingerprints. Such efficiency may be particularly significant in embodiments where data is being processed in real-time, or where a computing device executing the method 400 has lower processing capabilities, so that the method 400 may be completed autonomously in a timely manner that does not produce a significant delay.

Another aspect of embodiments of the present disclosure is that data quality or features may be identified and even potentially improved or enhanced. For instance, in an example audio signal, the audio signal may at times be clipped. Audio clipping may occur at a microphone, equalizer, amplifier, or other component. In some embodiments, for instance, an audio component may have a maximum capacity. If data is received that would extend beyond that capacity, clipping may occur to clip data exceeding the capacity or other ability of the component. The result may be data that can be reflected in a two-dimensional waveform, or in a three-dimensional data set as disclosed herein, with plateaus at the peaks of the data.

An aspect of harmonic analysis of some embodiments of the present disclosure, however, is that the harmonics may occur at higher frequencies relative to the fundamental frequency. At higher frequencies, more power is required to sustain a desired volume level and, as a result, the volume at harmonic frequencies often drops off more rapidly.

Because of the reduced amplitude, the frequency progressions at harmonic frequencies may not be clipped in the same manner as data at the fundamental frequency, or the clipping may be less significant. Once a fundamental frequency is therefore identified, the harmonic frequencies can also be determined. If there are significant differences in the fingerprints of the data at harmonic and fundamental frequencies, the data from the harmonic frequency progression may be inferred on the fundamental frequency progression. That is to say that methods and rates of change within the three dimensional data of a harmonic frequency progression—which data may correspond to changes to shape or waveforms if data is plotted—may be added to the data of the fundamental frequency progression to produce data that can be compared and determined to be identical or nearly identical. This process is generally represented by act 434 in FIG. 4. In such an embodiment, a frequency progression can be aliased using a harmonic frequency progression, and such action may potentially improve data quality or recover clipped or otherwise altered data. The aliased version of the frequency progression may then be saved as the fingerprint for a particular window, and can replace the fingerprint of the previously clipped data.

As discussed above, fingerprints may be compared within the same window segment to identify other like fingerprints, and the window segment information may then be reduced to one or a lesser number of fingerprints. In general, these window segments have the same start and end times, so that the audio or other information within the window often includes variations of the same information. Outside of a the same window segment, similar commonalities or other patterns may also be present, whether the data is audio data, visual data, digital data, analog data, compressed data, real-time data, file-based data, or other data, or any combination of the foregoing. Embodiments of the present disclosure may include evaluating fingerprints relative to fingerprints within different window segments and separating similar or identical data elements relative to non-similar data elements.

For instance, in the context of audio data, each person, device, machine, or other structure typically has the capability of producing sound which is unique in its structure, and which can be recognized using embodiments of the present disclosure to identify commonalities in data elements corresponding to the particular sound source. Even a person speaking different words or syllables may produce sound with common traits that allow the produced audio data to be compared and determined to be similar to a high probability.

The ability to compare audio or other data may allow embodiments of the present disclosure to effectively interpret data and separate common elements, such as sounds from a particular source, over prolonged periods of time, at different locations, which are produced using different equipment, or based on a variety of other types of differing conditions. One manner of doing so is to compare fingerprints of different window segments. Fingerprints of different segments can be compared to identify other data elements with commonalities, or even compared relative to patterns known to be associated with a particular source.

In some embodiments of the present disclosure, information about window segments and/or fingerprints may be stored so as to allow comparisons across multiple window segments. Additional information about window segments and/or fingerprints may be stored in the fingerprint table 1300 of FIG. 13, for instance. The fingerprint table 1300 may include an ID portion where window segments may be identified. As with the global hash table 1200 of FIGS. 12A-12C, and the window table 1100 of FIG. 11, the ID for each window segment may be consistent. In other words, the same window segment may optionally be referenced in each of the tables 1100, 1200 and 1300 using the same ID value. In other embodiments, rather than referencing individual window segments, identifications of fingerprints may be used. In such a case, one or more of the illustrated tables, or an additional table, may provide information about to which window segment each fingerprint corresponds.

Also within the fingerprint table 1300 may be a fingerprint section where fingerprints of frequency progressions may be stored. As noted above, in one embodiment, the act 426 of method 400 in FIG. 4 may include storing in the fingerprint section point cloud data, or a representation thereof, for an identified frequency progression, although storing of the fingerprint data may occur at any time or in any number of different locations. In a particular example embodiment, a data blob may be stored in the fingerprint section, with the data blob including three-dimensional point cloud information for a single fingerprint. FIG. 10 illustrates a single frequency progression 1000 that may be traced or otherwise identified within the window segment 900 of FIG. 9. The point cloud data, or other data that defines the frequency progression 1000, including the respective points, methods and rates of change in three or more dimensions, and the like, may be stored as the fingerprint or used to generate a fingerprint. While a window segment may have a single fingerprint stored therefor, a window segment may also have multiple fingerprints stored or referenced with respect thereto. For instance, each window segments 0002-0007 may have a single fingerprint associated therewith; however, two fingerprints may be stored to correspond to window segment 0001. In some cases, the number of fingerprints stored for a given window segment can change over time. For instance, fingerprints may be reduced or combined as discussed herein.

With continued reference to FIG. 4, fingerprinting of window segments in step 420, reducing of fingerprints in step 428, and inferring data for a fundamental frequency progression in act 434 may generally each be performed on multiple window segments, with each window segment being treated in a separate and optionally parallel process. In continuing an example of the process in FIG. 4, once data fingerprinting has been completed for a window segment, a comparison may be performed to identify commonalities of fingerprints within one fingerprint relative to fingerprints of other window segments.

In act 436 of FIG. 4, for instance, a fingerprint may be compared to all other fingerprints. This act may include comparing only fingerprints that have been maintained after reduction of fingerprints in step 428. Additionally, in some cases, the comparison may be performed only for fingerprints obtained during a particular communication session, rather than all fingerprints of all time. In one example, information in the window table 1100, global hash table 1200, and fingerprint data 1300 may be cleared after a particular communication or data processing session ends, or after a predetermined amount of time. Thus, when a new communication or processing session commences, fingerprints that are compared may be newly identified fingerprints.

In other embodiments, fingerprint data may be persistently stored for comparative purposes. For instance, a set table 1400 such as that illustrated in FIG. 14 may be provided and used to store information. Each set may be identified, and can correspond to a unique pattern, which in the case of audio data may correspond to an audio source. One set may include, for instance, audio data deemed to be from a particular person's voice. A second set may include data elements produced by a particular musical instrument. Still another set may include the sound of a specific type of machinery operating within a manufacturing facility. Other sets of audio or other information may also be included.

Each set in table 1400 is shown as being identified using a reference. The reference may be of any suitable type, including GUIDS, or even common naming conventions. For instance, if a set of audio data is known to be associated with a particular person named “Steve”, the identifier could be the name “Steve.” Since the sets may correspond to audio sources, the set reference may also be independent of, and different from, the IDs representing window segments within the tables of FIGS. 11, 12A-12C and 13. The set table 1400 may also include representations of all of the fingerprints for a given set. By way of illustration, the set table 1400 may include a data blob that includes the data of a fingerprint for each similar fingerprint within a set. In other embodiments, information in the set table may be a pointer. Example pointers may point back to the fingerprint table 1300 of FIG. 13, in which the identified fingerprints may be stored as data blobs or as other structures. If the fingerprint table 1300 is cleared as discussed herein, data in the fingerprint table 1300 may be brought into the set table 1400, or the fingerprint table may only have portions thereof cleared (e.g., comparison data for other fingerprints of a same window segment or communication session).

When data within a time slice, data file, or other source is interpreted, fingerprints from multiple different window segments may be produced, reduced and/or grouped. In particular, a fingerprint at one point in time may have a likeness value matching that at another point in time. The act 436 of comparing fingerprints may thus also include annotating one or more of the tables of FIGS. 11-13 with data representing similarities between different fingerprints. FIG. 12C, for instance, illustrates a table 1200 in which fingerprints from multiple different window segments are referenced and compared. In this embodiment, for instance, an array—and optionally a multi-dimensional or nested array—may store information indicating the relative similarity of fingerprints FP₁₋₁ and FP₁₋₂ relative to each other and relative to other fingerprints FP₂₋₁ through FP₇₋₁.

A comparison of fingerprints in act 436 may also be performed in any of a number of different manners. Although optional, one embodiment may include using a system similar to that used in act 430 of FIG. 4. For instance, an edge overlay comparison may be used to compare two fingerprints. Under such a comparison, the relative rates and methods of change in values within each of three dimensions may be changed by overlaying one fingerprint relative to the other and scaling the fingerprints in each of three dimensions. Based on the similarities in the forms of the fingerprints, a likeness value can be obtained. Entire fingerprints may be compared or, as discussed above, partial portions of fingerprints may be compared, with certain components of a fingerprint optionally being weighted relative to other components.

In some cases, fingerprints that are compared can be reduced. For instance, in the context of audio data, two fingerprints may be close in time, such as where one fingerprint results from an echo, reverb, or other degradation to sound quality. In that case, the additional fingerprint can potentially be eliminated. For instance, it may be determined that a similar or identical fingerprint results from acoustic or other factors relative to a more dominant sample, and such fingerprint can then be eliminated. Alternatively, two fingerprints at the same point in time may be identified as identical or similar, and can be reduced. The resulting fingerprints can be identified in the global hash table 1200 of FIG. 12C and/or the fingerprint table 1300 of FIG. 13, and values or other data representative of similarities between different fingerprints may be included in the tables 1200, 1300.

In accordance with some embodiments of the present disclosure, some elements of a data set received in the method 400 may be separated relative to other data elements of the data set. Such separation may be based on the similarity of fingerprints to other fingerprints. As discussed herein, fingerprint similarity may be based on matching of patterns within data, which patterns may include identifying commonalities in rates and/or methods of change within a structure such as a fingerprint. In the context of a phone call, for example, it may be desired to isolate a speaker's voice on the outbound or inbound side of a phone call relative to other noise in the background. In such a case, a set of one or more fingerprints associated with the speaker may be identified based on the common aspects of the fingerprints, and then provided for output. Such selection may be performed in any manner. For instance, in accordance with some embodiments, an application executing the method 400 may be located on a phone device, and can autonomously separate the voice of a person relative to other sounds. By way of illustration, as a speaker talks, the speaker may provide audio information that is dominant relative to any other individual source. Within the three-dimensional representation of data, the dominant nature of the voice may be reflected as a data having the highest amplitude. The application or device executing the method 400 may thus recognize the voice as a dominant sample, separate fingerprints of data similar to that of the dominant sample, and then potentially only transmit or output fingerprints associated with that same voice. Identifying a dominant sample or frequency progression among other frequency progressions in one or multiple window segments may be one manner of identifying designated data sources or characteristics for output in act 438. In some cases, a computing application may be programmed to recognize certain structures associated with a voice or other audio data so that non-vocal sounds are less likely to be considered dominant, even if at a highest volume/amplitude.

In still other embodiments, data that is designated for output in act 438 may not be audio data, or may be identified in other manners. For instance, an application may provide a user interface or other component. When data is interpreted and one or more data elements separated based on their commonalities, the different sets of separated data elements may be available for selection. Such data sets may thus each correspond to particular fingerprints representative of a person or other source of audio data, a type of object in visual data, or some other structure or source. Selection of one or more of the separated data sets may be performed prior to processing data, during processing of data, or after processing and separation of data. In an example embodiment, comparisons of data elements may be performed relative to one or more designated fingerprint sets, and any fingerprint not sufficiently similar to a designated set may not be included in a separated data set.

Fingerprints meeting certain criteria may, however, be output and optionally stored in groups or sets that include other fingerprints determined to be similar. Such a grouping may be based on using a threshold likeness value as described herein, or in any of a number of different manners. For instance, if a likeness threshold value of 0.95 is statically or dynamically set for the method 400, a fingerprint with a 95% or higher similarity relative to a fingerprint designated for output may be determined to be similar enough to be considered derived from the same source, and thus prepared to be output. In other embodiments, a similarity of 95% may provide a sufficiently high probability that two elements of data are not only of the same data source, but are identical. In the context of voice audio data, a high probability of identical data sets may indicate not only that the same person is speaking, but that the same syllable or sound is being made.

In an embodiment where date elements are evaluated for similarities, a step 440 for adding fingerprints to a set may be performed. If a fingerprint is determined to have a likeness value below a desired threshold, the fingerprint may be discarded or ignored. Alternatively, the fingerprint may be used to build an additional set. In step 444, for instance, a new set may be created. Creation of the new set in step 444 may include creating a new entry to the set table 1400 of FIG. 14 and including a fingerprint in the corresponding fingerprint section of the table 1400, or a reference to such a fingerprint as may be stored in the fingerprint table 1300 of FIG. 13.

If, however, a fingerprint is produced and when interpreted and compared to other fingerprints is determined to be similar to one or more fingerprints of an existing set, the fingerprint may be separated from other data of the data set. In one embodiment, for instance, a fingerprint determined to be similar to other data of a set may be added to that set. As part of such a process, the fingerprint may be added in act 446 to an existing set of fingerprints that share commonalities with the to-be-added fingerprint.

In some cases, data determined to a high probability to match certain criteria set or identified in act 438 may be excluded from a data set, although in other embodiments all common data may be added to the data set. A data set in the table 1400 may include, for instance, a set of unique fingerprints that are determined to a sufficiently high probability to originate from the same source or satisfy some other criteria. Thus, two identical or nearly identical fingerprints may not be included in the same set. Rather, if two fingerprints are shown to be sufficiently similar that they are likely identical, the newly identified fingerprint could be excluded from the applicable set. Data fingerprints that are similar, but not nearly identical, may continue to be added to the data set.

To further illustrate this point, one example embodiment may include comparisons of fingerprints or other data elements relative to multiple thresholds. As an example, likeness data may be obtained and compared to a first threshold. If that threshold is satisfied, the method may consider the data to be identical to an already known fingerprint. Such a fingerprint may then be grouped with another fingerprint and considered as a single fingerprint, a pointer may be used to point to the similar fingerprint, the fingerprint may be eliminated or excluded from a set of similar and/or identical fingerprints, the fingerprint may be treated the same as a prior fingerprint, or the fingerprint may be treated in other manners. In one embodiment, for instance, a likeness value between 0.9 and 1.0 may be used to consider fingerprints as identical. In other embodiments, the likeness value for “identical” fingerprints may be higher or lower. For instance, a likeness value of 0.95 between two data elements may be used to indicate two elements should be treated as identical rather than as merely similar. A new entry may not necessarily then be added to a set within the set table 1400 of FIG. 14 as the fingerprint may be considered to be identical or equivalent to a fingerprint already contained therein.

Another threshold may then be utilized to determine similarity rather than equivalency. Utilizing the same example scale discussed herein, a threshold for equivalency may be set at or about a likeness value of 0.7. Any two fingerprints that are compared and have a likeness of at least 0.7—and optionally between 0.7 and an upper threshold—may be considered similar but not identical. In such a case, the new fingerprint may be added to a set where fingerprints are determined to have a high probability of originating from a same source, or are otherwise similar. Of course, this threshold value may also vary, and may be higher or lower than 0.7. For instance, in another embodiment, a lower likeness threshold may be between about 0.75 and about 0.9. In still another example embodiment, a lower likeness threshold for similarity may be about 0.8. In at least one embodiment, evaluation of likeness of fingerprints for similarity in audio data may produce sets of different words or syllables spoken by a particular person. In particular, although different words or syllables may be spoken, the patterns associated with the person's voice may provide a likeness value above 0.8 or some other suitable threshold. Thus, sets of fingerprints may over time continue to build and a more robust data set of comparatively similar, although not identical fingerprints may be developed.

According to some embodiments of the present disclosure, data considered to be “good” data may be output or otherwise provided. Such “good” data may, for instance, be written to an output buffer as shown in act 448 of FIG. 4. Data may be considered to be “good” when it is determined to have a sufficiently high probability of satisfying the designations identified in act 438. Such may occur within data that when fingerprinted shares commonalities with respect to method and/or rate of change in one or more dimensions. A fingerprint may, for instance, be known to be associated with a designated output source, and other fingerprints with sufficiently high likeness values relative to that fingerprint may be separated and output. Writing the good output to an output buffer, or otherwise providing separated data, may occur in real-time in some cases, such as where a telephone conversation is occurring. In particular, a fingerprint representing a frequency progression within a window segment of a time slice may be compared to other, known fingerprints of a source. Similar fingerprints may be isolated and the data corresponding thereto can be output. That fingerprint may also optionally be added to a set for the source.

In some embodiments, the fingerprint data itself may not be in a form that is suitable for output. Accordingly, in some embodiments, the fingerprint data may be transformed to another type of data, as represented by act 450. In the case of audio information, for instance, a three-dimensional fingerprint may be transformed back into two-dimensional audio data. Such a format may be similar to the format of information received into the method 400. In some embodiments, however, the data that is output may be different relative to the input data. An example difference may include the output data including data elements that have been separated relative to other received data elements, so that isolated or separated data is output. The isolated or separated data may share commonalities. Alternatively, data elements from multiple data sets may be output, with each set of data elements having certain commonalities. In at least one embodiment, transforming the three-dimensional data into a two-dimensional representation may include performing a Laplace transform on the three-dimensional fingerprint data, or on a two-dimensional representation of the three-dimensional fingerprint data, to transform data to another two-dimensional domain. For audio information, for instance, time/frequency/amplitude data may be transformed into data in a time/amplitude domain.

When data is transformed, it may be output (see act 316 of FIG. 3). In at least some additional or alternative embodiments, information from one or more tables may be used to output the separated data. For instance, relative to the window table 1100 of FIG. 11, a particular fingerprint may be associated with a window segment having specific start and end times. A fingerprint may, therefore, be output by using the start and end time data. Start and end amplitude or other intensity data may also be used to writing audio data to an output stream so that the data is provided at the correct time and volume.

Accordingly, the method 400 may be used to receive data and interpret the data by analyzing data elements within the data against other data elements to determine commonalities. Data sharing commonalities may then be separated from other data and output or saved as desired. FIG. 16 illustrates two example waveforms 1600a, 1600b which each represent data that may be output following processing of the waveform 500 of FIG. 5 to interpret and separate sound of a particular source. Waveforms 1600a, 1600b may each correspond to data having a likelihood of being associated with a same source, and each of waveforms 1600a, 1600b may be output separately, or an output may include both of waveforms 1600a, 1600b.

It should be appreciated in view of the disclosure herein that the methods of FIGS. 3 and 4 may be combined in any number of manners, and that various method acts and steps are optional, may be performed at different times, may be combined, or may otherwise be altered. Moreover, it is not necessary that the methods of FIGS. 3 and 4 operate on any particular type of data. Thus, while some examples reference audio data, the same or similar methods may be used in connection with visual data, analog data, digital data, encrypted data, compressed data, real-time data, file-based data, or other types of data.

Further, it should also be understood that the methods of FIGS. 3 and 4 may be designed to operate with or without user intervention. In one embodiment, for instance, the methods 300 and 400 may operate autonomously, such as by a computing device executing computer-executable instructions stored on computer-readable storage media or received in another manner. Commonalities within data can be dynamically and autonomously recognized and like data elements can be separated. In this manner, different structures for sounds or other types of data need not be pre-programmed, but can instead be identified and grouped on the fly. This can occur by, for instance, analyzing distinct data elements relative to other data elements within the same data set to determine those commonalities with respect to methods and/or rates of change of structure. Such structures may be defined in three-dimensions, and the rates and methods of change may be relative to an intensity value such as, but not exclusive to, volume or amplitude. Moreover, the methods 300 and 400 allow autonomous and retroactive reconstruction and rebuilding of data sets and output data. For instance, data sets can autonomously build upon themselves to further define data of a particular source or characteristic (e.g., voice data of a particular person or sounds made by a particular instrument). Even without user intervention, similar data can be added to a set associated with the particular source, whether or not such data is included in output data. Moreover, data that is separated can be rebuilt using fingerprints or other representations of the data. Such construction may be used to construct a full data set that is received, or may be used to construct isolated or separated portions of the data set as discussed herein.

As will be appreciated in view of the disclosure herein, embodiments of the present disclosure may utilize one or more tables or other data stores to store and process information that may be used in identifying patterns within data and outputting isolated data corresponding to one or more designated sources. FIGS. 11-14 illustrate example embodiments of tables that may be used for such a purpose.

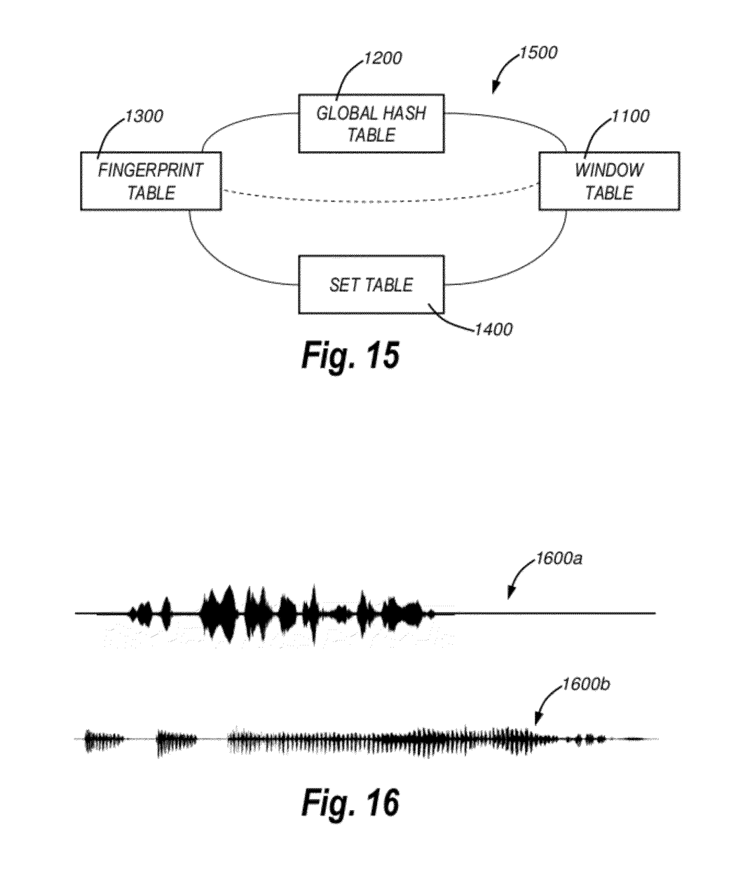

FIG. 15 schematically illustrates an example table system 1500 that includes each of a window table 1100, global hash table 1200, fingerprint table 1300 and set table 1400, and describes the interplay therebetween. In general, the tables may include data referencing other data or be used to read or write to other tables as needed during the process of interpreting patterns within data and isolating data of one or more designated sources. The tables 1100-1400 may generally operate in a manner similar to that described previously. For instance, the window table 1100 may store information that represents the locations of one or more window segments. The identification of those window segments may be provided to, or used with, identifications of the same window segments in the global hash table 1200 and/or the fingerprint table 1300. The window table 1100 may also be used with the set table 1400. For instance, as good data associated with a set is to be output, the identified fingerprint can be written to an output buffer using time, amplitude, frequency, or other data values stored in the window table 1100.

The global hash table 1200 may also be used in connection with the fingerprint table 1300. For instance, the global hash table 1200 may identify one or more fingerprints within a window segment, along with comparative likenesses among fingerprints in the same window segment. Same or similar fingerprints may be reduced or pointers may be included to reference comparative values of the similar fingerprint so that duplicative data need not be stored. The fingerprint table 1300 may include the fingerprints themselves, which fingerprints may be used to provide the comparative values for the global hash table 1200. Additionally, comparative or likeness data in the fingerprint table may be based on information in the global hash table 1200. For instance, if the global hash table 1200 indicates that two fingerprints are similar, the corresponding information may be incorporated into the fingerprint table 1300.

The set table 1400 may also interact with the fingerprint table 1300 or window table 1100. For instance, as described previously, the set table 1400 may include references to fingerprints that are within a defined set; however, the fingerprints may be stored in the fingerprint table 1300. Thus, the information in the set table 1400 may be pointers to data in the fingerprint table 1300. As also noted above, when good information for a set is identified for output, the information relative to time or other data values as stored in the window table 1100 may be used to output the known good value identified in the set table 1400.

In general, embodiments of the present disclosure may be used in connection with real-time audio communications or transmissions. Using such a process, data sets of information that have comparatively similar patterns may be dynamically developed and used to isolate desired sounds. Illustrative examples may include telephone conversations where data may be processed at an outbound, inbound or intermediate device and certain information may be isolated and included. The methods and systems of the present disclosure may operate on an inclusive basis where data satisfying a set criteria (e.g., as originating from a particular person or source) is included in a set. Such processing may be in contrast to exclusive processing where data is analyzed against as certain criteria and any information satisfying the criteria is excluded.

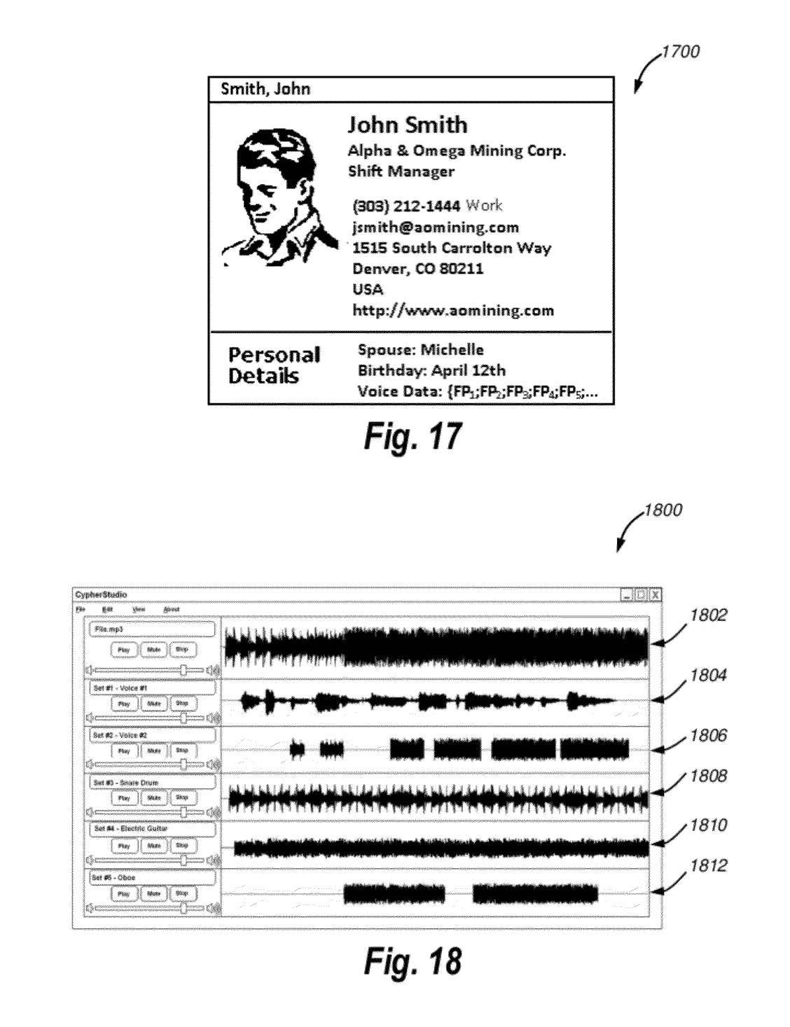

Embodiments of the present disclosure may be utilized in connection with many different types of data, communication or situations. Additionally, fingerprint, set or other pattern data may be developed and shared in any number of different manners. FIG. 17, for instance, illustrates a visual representation of a contact card 1700 that may be associated with a container for a person's personal information. In accordance with one embodiment, the card 1700 may include contact information 1702 as well as personal information 1704.

The contact information 1702 may generally be used to contact the person, whether by telephone, email, mail, at an address, etc. In contrast, the personal information 1704 may instead provide information about the person. Example personal details may include the name of a spouse or children, a person's birthday or anniversary date, other notes about the person, and the like. In one embodiment, the contact card 1700 may include information about the speech characteristics of the person identified by the contact information 1702. For instance, using methods of the present disclosure, different words or syllables that the identified person makes may be collected in a set of information and identified as having similar patterns. This information may be stored in a set table or other container as described herein. In at least the illustrated embodiment, the set information may also be extracted and included as part of a contact container. As a result, the person's vocal characteristics can be shared with others. In the event a telephone call is later initiated, a computing system having access to the contact container represented by the card 1700 may immediately begin to use or build upon the set of voice data, without a need to create a new set and then associate the set with a particular source.

In one embodiment, a telephone may access the fingerprints of voice data in the personal information 1704 to let a user of a device know who is on the other end of a phone call. For instance, a phone call may be made from an unknown number or even the number of another known person. If “John Smith” starts talking, the incoming phone may be able to identify the patterns of speech and compare them to the fingerprints of the voice data stored for John Smith. Upon detecting that the speech patterns match those of the fingerprints, an application on the phone may automatically indicate that the user is speaking with John Smith, whether by displaying the name “John Smith”, by displaying an associated photograph, or otherwise giving an indication of the speaker on the other end of a call.

Embodiments of the present disclosure may also be used in other environments or circumstances. For instance, the methods and systems disclosed herein, including the methods of FIGS. 3 and 4, may be used for interpreting data that is not audio data and/or that is not real-time data. For instance, file-based operations may be performed on audio data or other types of data. For instance, a song may be stored in a file. One or more people may be singing during the song and/or one or more instruments such as a guitar, keyboard, bass, or drums may each be played. On a live recording, crowd cheering and noise may also be included in the background.

That data may be analyzed in much the same way as described above. For instance, with reference to FIG. 3, data may be accessed. The data may then be contained or isolated using the method of FIG. 4. In such a method, the data may be transformed from a two-dimensional representation into a three-dimensional representation. Such a file need not be sliced as shown in FIG. 4, but may instead be processed as whole by identifying window segments within the entire file, rather than in a particular time slice. Deviations from a noise floor or other baseline can be identified and marked. Where time slices are not created, there may not be a need to identify overlaps as shown in FIG. 4. Instead, frequency progressions of all window segments can be fingerprinted, compared and potentially reduced. In some cases, one or more output sets can be identified. For instance, FIG. 18 illustrates an example user interface 1800 for an application that can analyze a file, which in this particular embodiment may be an audio file. In the application, audio information from a file has been accessed and interpreted. Using a comparison of data elements to other elements within the data set in a manner consistent with that disclosed herein, different sets of data elements with a high probability of being from the same source have been identified.

In the particular embodiment illustrated in FIG. 18, for instance, the original file 1802 may be provided, along with each of five different sets of data elements have been identified. These elements may include two voice data sets 1804, 1806 and three instrumental data sets 1808-1812. The separation of each set may be done autonomously based only on common features within the analyzed file 1802. In other embodiments, other data sets previously produced using autonomous analysis of files or other data may also be used in determining which features of an audio file correspond to particular sets.

Once the file is analyzed, each set 1804-1812 may be presented via the user interface 1800. Such sets may be independently selected by the user, and each set may optionally be output as a separate file or played independent of other sets. In some embodiments, sets may be selected and combined in any manner. For instance, of a user wants to play everything except the voices, the user could select to play each of sets 1808-1812. If a user wanted to hear only the main vocals, the user could select to play only set 1804. Of course any other combination may be used so that separated audio can be combined in any manner as desired by a user, and in any level of granularity. In this manner, a user may be able to perform an analysis of audio data and separate or isolate particular audio sources, without the need for highly complex audio mixing equipment or the knowledge of how to use that equipment. Instead, data that is received can be presented and/or reconstructed autonomously based on patterns identified in the data itself.

Embodiments of the present disclosure may generally be performed by a computing device, and more particularly performed in response to instructions provided by an application executing on the computing device. Therefore, in contrast to certain pre-existing technologies, embodiments of the present disclosure may not require specific processors or chips, but can instead be run on general purpose or special purpose computing devices once a suitable application is installed. In other embodiments, hardware, firmware, software, or any combination of the foregoing may be used in directing the operation of a computing device or system.

Embodiments of the present disclosure may thus comprise or utilize a special purpose or general-purpose computer including computer hardware, such as, for example, one or more processors and system memory, as discussed in greater detail herein. Embodiments within the scope of the present disclosure also include physical and other computer-readable media for carrying or storing computer-executable instructions and/or data structures, including applications, tables, or other modules used to execute particular functions or direct selection or execution of other modules. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media.

Examples of computer storage media include RAM, ROM, EEPROM, CD-ROM or other optical disk storage, magnetic disk storage or other magnetic storage devices, or any other non-transmission medium which can be used to store desired program code means in the form of computer-executable instructions or data structures and which can be accessed by a general purpose or special purpose computer.

A “communication network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmissions media can include a communication network and/or data links, carrier waves, wireless signals, and the like, which can be used to carry desired program or template code means or instructions in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, servers, and the like.

Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote memory storage devices.

### INDUSTRIAL APPLICABILITY

In general, embodiments of the present disclosure relate to autonomous, dynamic systems and applications for interpreting and separating data. Such autonomous systems may be able to analyze data based solely on the data presented to identify patterns, without a need to refer to mathematical, algorithmic, or other predetermined definitions of data patterns. Data that may be interpreted and separated according to embodiments of the present disclosure may include real-time data, stored data, or other data or any combination of the foregoing. Moreover, the type of data that is analyzed may be varied. Thus, in some embodiments, analyzed data may be audio data. In other embodiments, however, data may be image data, video data, stock market data, medical imaging data, or any number of other types of data.

Examples are disclosed herein wherein audio data may be obtained real-time, such as in a telephone call. Systems and applications contemplated herein may be used at the end-user devices, or at any intermediate location. For instance, a cell phone may run an application consistent with the disclosure herein, which interprets and separates audio received from the user of the device, or from the user of another end-user device. The data may be analyzed and data of a particular user may be separated and isolated from background or other noise. Thus, even in a noisy environment, or a system where data compression adds noise to the data, a person's voice may be played with clarity. Similarly, a system may interpret and separate data while remote from the end-user devices. A cell phone carrier may, for instance, run an application at a server or other system. As voice data is received from one source, the data may be interpreted and a user's voice separated from other noise due to environmental, technological, or other sources. The separated data may then be transmitted to the other end user(s) in manner that is separated from the other noise. In some embodiments, a cell phone user or a system administrator may be able to set policies or turn applications on/off so as to selectively interpret and isolate data. A user may, for instance, only turn on a locally running application when in a noisy environment, or when having difficulty hearing another caller. A server may execute the application selectively upon input from the end users or an administrator. In some cases, the application, system or session can be activated or deactivated in the middle of a telephone call. For instance, an example embodiment may be used to automatically detect a speaker on one end of a telephone call, and to isolate the speaker's voice relative to other noise or audio. If the phone is handed to another person, the application may be deactivated, or a session may be restarted, manually or automatically so that the voice of the new speaker can be heard and/or isolated relative to other sounds.

In accordance with another aspect, systems, devices, and applications of the present disclosure may be used with audio data in a studio setting. For instance, a music professional may be able to analyze recorded music using a system employing aspects disclosed herein. Specific audio samples or instruments may be automatically and effectively detected and isolated. A music professional could the extract only a particular track, or a particular set of tracks. Thus, after a song is produced, systems of the present disclosure can automatically de-mix the song. Any desired track could then be remixed, touched-up or otherwise altered or tweaked. Any white noise, background noise, incidental noise, and the like can also be extracted and eliminated before samples are again combined. Indeed, in some embodiments, instructions given audibly to a person or group producing the music can even be recorded and effectively filtered out. Thus, audio mixing and mastering systems can incorporate aspects of the present disclosure and music professionals may save time and money while the system can autonomously, efficiently, effectively, and non-destructively isolate specific tracks.

According to additional embodiments of the present disclosure, other acoustic devices may be used in connection with the present disclosure. For instance, hearing aids may beneficially incorporate aspects of the present disclosure. In accordance with one embodiment, using applications built into a hearing aid or other hearing enhancement device, or using applications interfacing with such devices, a hearing aid may be used to not only enhance hearing, but also to separate desired sounds from unwanted sounds. In one example, for instance, a hearing aid user may have a conversation with one or more people while in a public place. The voices of those engaged in the conversation may be separated from external and undesired noise or sounds, and only those voices may be presented using the hearing aid or other device.

Such operation may be performed in connection with an application running on a mobile device. Using wireless or other communication, the hearing aid and mobile device may communicate, and the mobile device can identify all the different sounds or sources heard by the hearing aid. The user could sort or select the particular sources that are wanted, and that source can be presented in a manner isolated from all other audio sources.

Using embodiments of the present disclosure, other features may also be realized. A person using a hearing aid may, for instance, set an alert on a mobile or other application. When the hearing aid hears a sound that corresponds to the alert, the user can be notified. The user may, for instance, want to be notified if a particular voice is heard, if the telephone rings, if a doorbell rings, or the like, as each sound may be consistent with sets of fingerprints or other data corresponding to that particular audio source.

Other audio-related fields may include use in voice or word recognition systems. Particular fingerprints may, for instance, be associated with a particular syllable or word. When that fingerprint is encountered, systems according to the present disclosure may be able to detect what word is being said—potentially in combination with other sounds. Such may be used to type using voice recognition systems, or even as a censor. For instance, profanity may be isolated and not output, or may even be automatically replaced with more benign words.

Still other audio uses may include isolation of sounds to improve sleeping habits. A spouse or roommate who snores may have the snoring sounds isolated to minimize disruptions during the night. Sirens, loud neighbors, and the like may also be isolated. In another context, live events may be improved. Microphones incorporating or connected to systems of the present disclosure may include sound isolation technology. Crowd or other noise may be isolated so as not to be sent to speakers, or even for a recording a live-event may be recorded to sound like a studio production.

In accordance with still another example embodiment, other areas may benefit from the technology disclosed herein. In one embodiment, for instance, phone calls or other conversations may be recorded or overheard. The information can be interpreted and analyzed, and compared to other information on file. The patterns of speech of one person may be used to determine if a voice is a match for a particular person, so that regardless of the equipment used to capture the sound, the location of origin, or the like, the person can be reliably identified. Patterns of a particular voice may also be recognized and compared in a voice recognition system to authenticate a user for access to files, buildings or other resources.

A similar principle can be used to identify background sounds. A train station announcement may be separated and heard to be consistent with a particular train or location, so that a location of a person heard to be nearby may be more easily identified, even without sophisticated audio mixing equipment. Of course, a train station announcement is merely one example embodiment, and other sounds could also be identified. Examples of other sounds that could be identified based on a recognition of patterns and commonalities of elements within the sound data may include identifying a particular orchestra or even instruments in a specific orchestra (e.g., a particular Stradivarius violin). Other sounds that could be identified include sounds of specific animals (e.g., sounds specific to a type of bird, primate or other animal), sounds specific to machines, (e.g., manufacturing equipment, elevators or other transport equipment, airport announcements, construction or other heavy equipment, etc.), or still other types of sounds.

Data other than audio data may also be analyzed and interpreted. For instance, images may be scanned and the data analyzed using the autonomous pattern recognition systems disclosed herein. In a medical field, for instance, x-rays, MRIs, EEGs, EKGs, ultrasounds, CT scans, and the like may generate images that are often difficult to analyze. With embodiments of the present disclosure, the images can be analyzed. Data that is produced due to harmonic distortion can be reduced using embodiments herein. Moreover, as materials having different densities, composition, reflection/refraction characteristics, or other elements are encountered, each can produce a unique fingerprint to allow for efficient identification of the material. A cancerous tumor may, for instance, have a different make-up than normal tissue or even a benign tumor. Through autonomous and non-invasive techniques, images may be analyzed to detect not only what the material is—and without the need for a biopsy—but where it is located, what size it is, if it has spread within the body, and the like. At an even more microscopic level, a particular virus that is present may be detected so that even obscure illnesses can be quickly diagnosed.

Accordingly, embodiments of the present disclosure may relate to autonomous, dynamic interpretation and separation of real-time data, stored data, or other data, or any combination of the foregoing. Moreover, data that may be processed and analyzed is not limited to audio information. Indeed, embodiments described herein may be used in connection with image data, video data, stock market information, medical imaging technologies, or any number of other types of data where pattern detection would be beneficial.

Although the foregoing description contains many specifics, these should not be construed as limiting the scope of the invention or of any of the appended claims, but merely as providing information pertinent to some specific embodiments that may fall within the scopes of the invention and the appended claims. Various embodiments are described, some of which incorporate differing features. The features illustrated or described relative to one embodiment are interchangeable and/or may be employed in combination with features of any other embodiment herein. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. A computer-implemented method for interpreting and separating data elements of a data set, comprising:
accessing a data set using a computing system;
automatically interpreting the data set using the computing system, wherein interpreting the data set includes comparing a method and rate of change of each respective one of a plurality of elements within the data set relative to each other of the plurality of elements within the data set; and
using the computing system, separating the data set into one or more set components, each set component including data elements having similar structures in methods and rates of change.

2. The method recited in claim 1, wherein analyzing methods and rates of change of structures includes considering methods and rates of change to an intensity value of the accessed data set.

3. The method recited in claim 1, wherein analyzing methods and rates of change includes:
generating fingerprints of data having three or more dimensions; and
comparing the generated fingerprints of the data of three or more dimensions.

4. The method recited in claim 3, wherein comparing the generated fingerprints includes scaling at least one fingerprint in any or all of the three or more dimensions and comparing the scaled at least one fingerprint to another fingerprint.

5. The computer-implemented method of claim 1, wherein the accessed data set is real-time data.

6. The computer-implemented method of claim 1, wherein the accessed data set is file-based, stored data.

7. The computer-implemented method of claim 1, wherein automatically interpreting the data set using the computing system includes:
transforming the accessed data set from a two-dimensional representation into a representation of three or more dimensions; and
comparing methods and rates of change in the three or more dimensions of the representation of three or more dimensions.

8. The computer-implemented method of claim 1, wherein the accessed data is data of a telephone call.

9. The computer-implemented method of claim 8, wherein the computing system accessing the data set, interpreting the data set, and separating the data set is:
an end-user telephone device; or
a server relaying communications between at least two end-user telephone devices.

10. The computer-implemented method of claim 8, wherein interpreting and separating the data set introduces a delay in the telephone call, wherein the delay is less than about 500 milliseconds.

11. The computer-implemented method of claim 1, wherein interpreting and separating the data set includes identifying one or more identical data elements and reducing identical data elements to a single data element.

12. The computer-implemented method of claim 1, wherein interpreting and separating the data set non-essentially includes identifying repeated data at harmonic frequencies.

13. The computer-implemented method of claim 12, wherein identifying repeated data at harmonic frequencies includes aliasing a first data element using a second data element at a harmonic frequency.

14. A system for interpreting and separating data elements of a data set, comprising:
one or more computer-readable storage media having stored thereon computer-executable instructions that, when executed by one or more processors, causes a computing system to:
access a set of data;
autonomously identify commonalities between elements within the set of data, and without reliance on pre-determined data types or descriptions; and
separate elements of the set of data from other elements of the set of data based on the autonomously identified commonalities.

15. The system recited in claim 14, wherein autonomous identification of commonalities between elements includes evaluating elements of the set of data and identifying similarities in relation to methods and rates of change.

16. The system recited in claim 14, wherein the set of data includes elements from a first source and elements from one or more additional sources, and wherein separating elements of the set of data includes including as output a first group of elements determined to have a high likelihood of originating from the first source, and elements determined to have a high likelihood of originating from the one or more additional sources not being included in the output.

17. A system for autonomously interpreting a data set and separating like elements of the data set, comprising:
one or more processors; and
one or more computer-readable storage media having stored thereon computer-executable instructions that, when executed by the one or more processors, cause the system to:
access one or more sets of data;
interpret the one or more sets of data, wherein interpreting the one or more sets of data includes autonomously identifying data elements having a high probability of originating from or identifying a common source; and
reconstruct at least a portion of the accessed one or more sets of data from the interpreted data, the reconstructed portion of the accessed sets of data including a first set of data elements of the one or more sets of data which were determined to have a high probability of originating from or identifying a common source.

18. The system recited in claim 17, wherein autonomously identifying data elements having a high probability of originating from or identifying a common source includes comparing data elements within the one or more sets of data relative to other elements also within the one or more sets of data and identifying elements sharing commonalities.

19. The system recited in claim 17, wherein reconstructing the accessed one or more sets of data from the interpreted data includes outputting at least the first set of data elements determined to have a high probability of originating from or identifying the common source to a file or a real-time stream.

20. The system recited in claim 19, wherein the accessed one or more sets of data include two-dimensional data and wherein reconstructing the accessed one or more sets of data from the interpreted data includes transforming the data elements of the first set of data elements from three or more dimensions to two-dimensional data.

21. A method for interpreting and separating data into one or more constituent sets, comprising, in a computing system:
accessing data of a first format;
transforming the accessed data from the first format into a second format;
using the data in the second format to identify a plurality of window segments, each window segment corresponding to a continuous deviation within the transformed data;
generating one or more fingerprints for each of the plurality of window segments;
comparing the one or more fingerprints and determining a similarity between the one or more fingerprints; and
separating the fingerprints meeting or exceeding a similarity threshold relative to other fingerprints below the similarity threshold.

22. The method of claim 21, wherein the accessed data is two-dimensional data and transforming the accessed data includes transforming the two-dimensional data to data of three or more dimensions.

23. The method of claim 21, wherein transforming the accessed data from the first format into a second format includes performing an intermediary transformation such that data is transformed into a third format.

24. The method of claim 21, wherein identifying a plurality of windows includes setting each window segment to start and begin when a continuous deviation starts and ends relative to a baseline.

25. The method of claim 24, wherein the baseline is a characteristic of a noise floor.

26. The method of claim 21, wherein generating one or more fingerprints for each of the plurality of window segments includes identifying one or more frequency progressions within each of the one or more window segments.

27. The method of claim 26, further comprising reducing the number of frequency progressions within the one or more window segments when frequency progressions within a particular window segment are identical or nearly identical.

28. The method of claim 21, wherein generating one or more fingerprints includes identifying one or more harmonic frequencies relative to a fundamental frequency.

29. The method of claim 28, further comprising inferring data for a fundamental frequency based on data available in a corresponding harmonic frequency.

30. The method of claim 21, wherein comparing the one or more fingerprints is performed:
on fingerprints generated from a same window segment; and
on fingerprints generated from different window segments.

31. The method of claim 21, wherein separating the fingerprints includes defining a new fingerprint set that includes fingerprints meeting or exceeding the similarity threshold.

32. The method of claim 21, wherein separating the fingerprints includes adding the fingerprints meeting or exceeding the similarity threshold to an existing fingerprint set.

33. The method of claim 21, wherein separating the fingerprints includes adding to a fingerprint set only fingerprints between two threshold values determined based on a comparison to fingerprints already in the fingerprint set.

34. The method of claim 21, wherein separating the fingerprints includes outputting real-time or file data, the output data including only the fingerprints meeting or exceeding one or more similarity thresholds.

35. The method of claim 21, wherein separating the fingerprints includes outputting data corresponding to the fingerprints meeting or exceeding the similarity threshold by converting the fingerprints into the first format.

36. The method of claim 21, the method further including outputting separated data that is a subset of the accessed data.

37. The method of claim 21, the method further including placing a time restraint on at least the acts of transforming the accessed data, identifying the window segments, generating the one or more fingerprints, comparing the one or more fingerprints, and separating the fingerprints.

38. The method of claim 37, wherein when the time restraint is exceeded, accessed data is output rather than separated data.

39. The method of claim 21, wherein comparing the one or more fingerprints includes comparing first and second fingerprints, wherein at least one of the first or second fingerprints is scaled in any or all of three or more dimensions.

40. The method of claim 21, wherein the accessed data includes one or more of audio data, image data or video data.
